(19) United States
(12) Patent Application Publication
(10) Pub. No.: US 2014/0009600 A1
(43) Pub. Date: Jan. 9, 2014

(54) MOBILE DEVICE, COMPUTER PRODUCT, AND INFORMATION PROVIDING METHOD

(71) Applicant: FUJITSU LIMITED, Kawasaki-shi (JP)

(72) Inventor: Takehiko IBAMOTO, Minato (JP)

(73) Assignee: FUJITSU LIMITED, Kawasaki-shi (JP)

(21) Appl. No.: 14/026,450

(22) Filed: Sep. 13, 2013

Related U.S. Application Data
(63) Continuation of application No. PCT/JP2011/056115, filed on Mar. 15, 2011.

(51) Int. Cl. G06Q 50/02; H04N 5/225

(52) U.S. Cl. CPC G06Q 50/02; H04N 5/225
USPC 348/89

(57) ABSTRACT

A mobile device includes a processor; and an imaging unit that records subjects as images. The processor is configured to detect an input operation of selecting an item among a group of items representing any among an object and an event possibly motivating a recording of a subject by a person engaged in farm work, output a record instruction to the imaging unit upon detecting the input operation, correlate the item for which the input operation is detected and an image that is recorded by the imaging unit consequent to the output record instruction, and output a result of correlation.

### CROSS REFERENCE TO RELATED APPLICATIONS

This application is a continuation application of International Application PCT/JP2011/056115, filed on Mar. 15, 2011 and designating the U.S., the entire contents of which are incorporated herein by reference.

### FIELD

The embodiments discussed herein are related to a mobile device, work support program, information providing method, and information providing program that support work.

### FIELD

The embodiments discussed herein are related to a mobile device, work support program, information providing method, and information providing program that support work.

### BACKGROUND

Conventionally, information is shared among persons engaged in agriculture. For example, by sharing pictures of a field taken on site, the state of the field, the state of crop growth as well as the occurrence of disease and pests can be confirmed by multiple users.

Related technology includes a technique of acquiring the current position in response to the pressing of a shutter button, and recording image and the current position to a recording medium. A further technique involves referring to an agricultural work log database, and identifying an employee and field from the position information of a terminal carried by the employee to thereby narrow down the work items to be performed by the employee. Yet another technique involves correlating image information and memo information entered through a screen displaying the image information, and storing the correlated image and memo information to a recording medium.

For examples of such technologies, refer to Japanese Laid-Open Patent Publication Nos. 2010-10890, 2005-124538, and H4-156791.

Nonetheless, with the conventional technologies, a person viewing a recorded image may have difficulty determining the purpose for which the image was recorded. For example, even for an image that is recorded to report the occurrence of pests and shows pests on crops, the person viewing the image may mistakenly think that the image merely shows the state of growth of the crops, inviting a problem of wide-spread pest damage.

Further, in the course of performing farm work, workers often wear gloves to protect their hands and consequently, for example, the operation of a computer to input notes concerning an image recorded onsite is difficult.

### SUMMARY

According to an aspect of an embodiment, a mobile device includes a processor; and an imaging unit that records subjects as images. The processor is configured to detect an input operation of selecting an item among a group of items representing any among an object and an event possibly motivating a recording of a subject by a person engaged in farm work, output a record instruction to the imaging unit upon detecting the input operation, correlate the item for which the input operation is detected and an image that is recorded by the imaging unit consequent to the output record instruction, and output a result of correlation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a work support process of a mobile device according to a first embodiment;

FIG. 2 is a diagram depicting an example of system configuration of a work support system according to a second embodiment;

FIG. 3 is a block diagram of an example of a hardware configuration of the mobile device according to the second embodiment;

FIG. 4 is a block diagram of an example of a hardware configuration of an information providing apparatus according to the second embodiment;

FIG. 5 is a diagram depicting an example of the contents of a field DB;

FIG. 6 is a diagram depicting an example of work plan data;

FIG. 7 is a block diagram of a functional configuration of the information providing apparatus according to the second embodiment;

FIG. 8 is a diagram of depicting an example of the contents of a item list (part 1);

FIG. 9 is a diagram depicting an example of the contents the item list (part 2);

FIG. 10 is a diagram depicting an example of the contents of the item list (part 3);

FIG. 11 is a diagram depicting an example of the contents of a pest list;

FIG. 12 is a diagram depicting an example of the contents of the item list (part 4);

FIG. 13 is a diagram depicting the contents of a disease list;

FIG. 14 is a diagram depicting an example of the contents of the item list (part 5);

FIG. 15 is a diagram depicting an example of the contents of a work plan table;

FIG. 16 is a block diagram of a functional configuration of the mobile device according to the second embodiment;

FIGS. 17A and 17B are diagrams depicting an example of the contents of a set item table;

FIG. 18 is a diagram depicting the contents of a correlated result table 1800;

FIG. 19 is a flowchart of a procedure of the information providing process by the information providing apparatus according to the second embodiment;

FIG. 20 is a flowchart of a procedure of the work support process performed by the mobile device according to the second embodiment;

FIGS. 21A, 21B, and 21C are diagrams depicting examples of screens displayed on a display of the mobile device according to the second embodiment (part 1);

FIGS. 22A, 22B, and 22C are diagrams depicting examples of screens displayed on the display of the mobile device according to the second embodiment (part 2);

FIGS. 23A, 23B, and 23C are diagrams depicting examples of screens displayed on the display of the mobile device according to the second embodiment (part 3);

FIGS. 24A, 24B, and 24C are diagrams depicting examples of screens displayed on the display of the mobile device according to the second embodiment (part 4);

FIG. 25 is a diagram depicting an example of a screen displayed on the display of the information providing apparatus according to the second embodiment;

FIG. 26 is a diagram depicting an example of a tree-structure;

FIG. 27 is a flowchart of a procedure of the work support process performed by the mobile device according to a third embodiment; and

FIGS. 28A, 28B, 28C, 29A, 29B, 30A, and 30B are diagrams depicting screen examples of the display of the mobile device according to the third embodiment.

### DESCRIPTION OF EMBODIMENTS

Embodiments of mobile device, work support program, information providing method, and information providing program will be described in detail with reference to the accompanying drawings. The embodiments can be combined to an extent that contradictions do not arise.

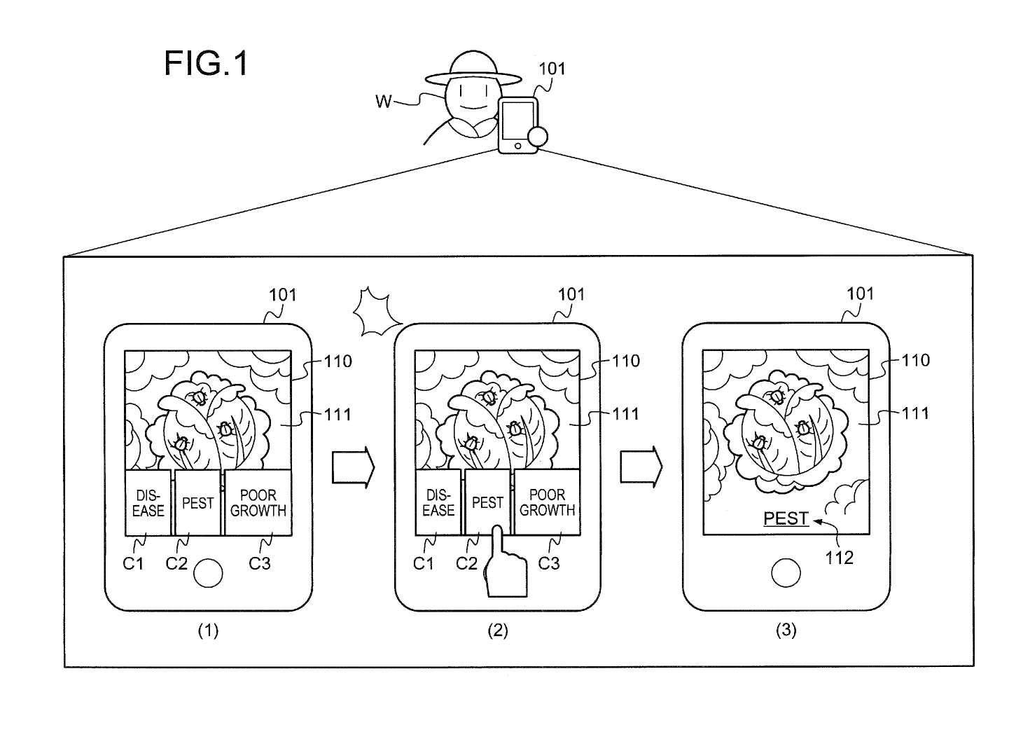

FIG. 1 is a diagram depicting an example of a work support process of a mobile device according to a first embodiment. In FIG. 1, a mobile device 101 is a computer that is used by a worker W. The mobile device 101 has a function of recording still and moving images.

A worker W is a person engaged in agriculture. The worker W records images of fields, crops, etc. as one sphere of farm work. A field is farmland for cultivating and raising crops. Crops are, for example, agricultural products such as grains and vegetables grown on farms, etc. Images of fields, crops, etc. are recorded for various purposes such as to show the state of a field, growth of crops, an occurrence of pests, etc.

Therefore, even if images are of the same field, depending on the purpose of recording the images, the point of interest of each image may differ. Thus, in the first embodiment, to make it easier for a person viewing an image to determine the intended purpose of the image, a technique correlate an image and an intended purpose by a simple input operation will be described.

An example of a procedure of the work support process by the mobile device 101 according to the first embodiment will be described. Here, description will be given taking as an example, a case where a worker W records an image of aphids on cabbage to report the occurrence of pests (aphids) in a field.

(1) The mobile device 101 detects an input operation of selecting an item among a group of items representing intended image recording purposes of a person who is engaged in farm work. Here, an item that represents an intended purpose is that which represents an object (e.g., a field, a crop, a pest) or an event (e.g., an occurrence of disease or pests, poor growth) that may have motivated the recording of the image.

An item that represents an intended purpose, for example, is expressed by text, symbols, figures, or any combination thereof. In the example depicted in FIG. 1, as examples of items representing intended purposes, items C1 to C3, which represent an occurrence of disease, an occurrence of pests, and poor growth, are displayed on a display 110 together with the subject to be recorded. The worker W selects an item from among the items C1 to C3, according to the intended purpose of recording the subject.

(2) The mobile device 101, upon detecting an input operation selecting an item among the group of items C1 to C3, records an image of the subject displayed on the display 110. In other words, interlocked with the input operation selecting an item by the worker W, the subject is recorded. In the example depicted in FIG. 1, consequent to the item C2 being selected by the worker W, an image 111 is recorded that includes cabbage cultivated in a field and aphids on the cabbage.

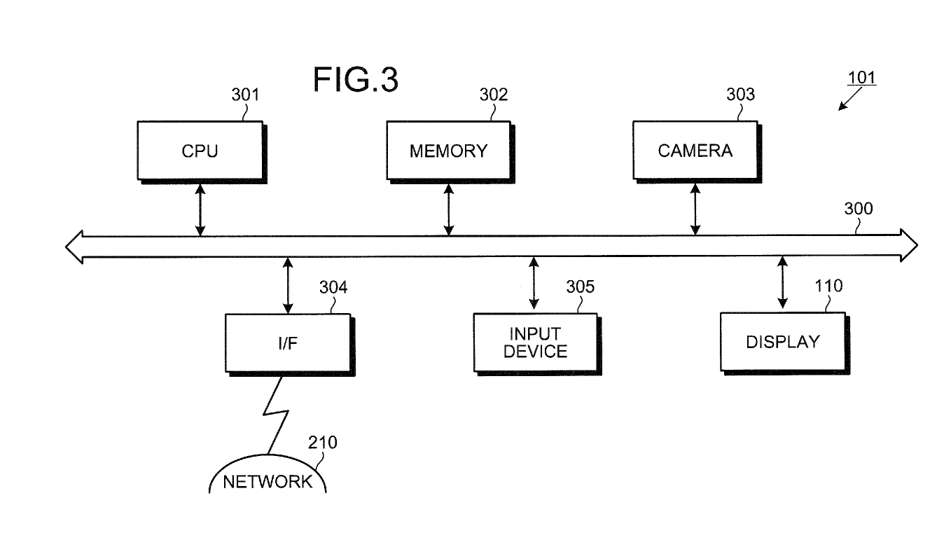

(3) The mobile device 101 correlates and outputs the recorded image 111 and the item C2 for which the input operation was detected. For example, the mobile device 101 correlates the image 111 and the item C2, and records the image 111 and the item C2 to memory (e.g., memory 302 depicted in FIG. 3 and described hereinafter). In the example depicted in FIG. 1, the image 111 together with item details 112 (pest) of the item C2 are displayed on the display 110.

As described, the mobile device 101 according to the first embodiment enables the image 111 recorded by the worker W and the intended purpose of the worker W to be correlated. Further, since the subject is recorded interlocked with the input operation selecting the item C2 by the worker W, the image 111 and the intended purpose can be correlated by an easy operation.

Further, since the item details 112 (pest) of the item C2 are displayed with the image 111 when the image 111 is viewed, the person viewing the image 111 can easily determine the intended purpose of the worker W whereby, the occurrence of pests (aphids) in the field can be quickly grasped and the spread of pest damage can be suppressed.

Next, a work support system according a second embodiment will be described. Description of aspects identical to those of the first embodiment will be omitted hereinafter.

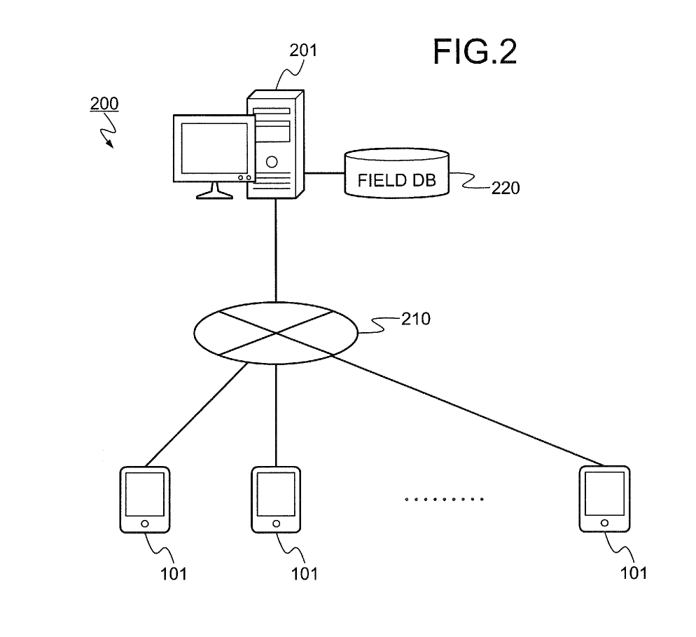

FIG. 2 is a diagram depicting an example of system configuration of the work support system according to the second embodiment. In FIG. 2, a work support system 200 includes the mobile device 101 in plural (in FIG. 2, only 3 devices are depicted) and an information providing apparatus 201. In the work support system 200, the mobile devices 101 and the information providing apparatus 201 are connected through a network 210 such as the Internet, a local area network (LAN), and a wide area network (WAN). A communication line connecting the information providing apparatus 201 and the mobile devices 101 may be wireless or wired.

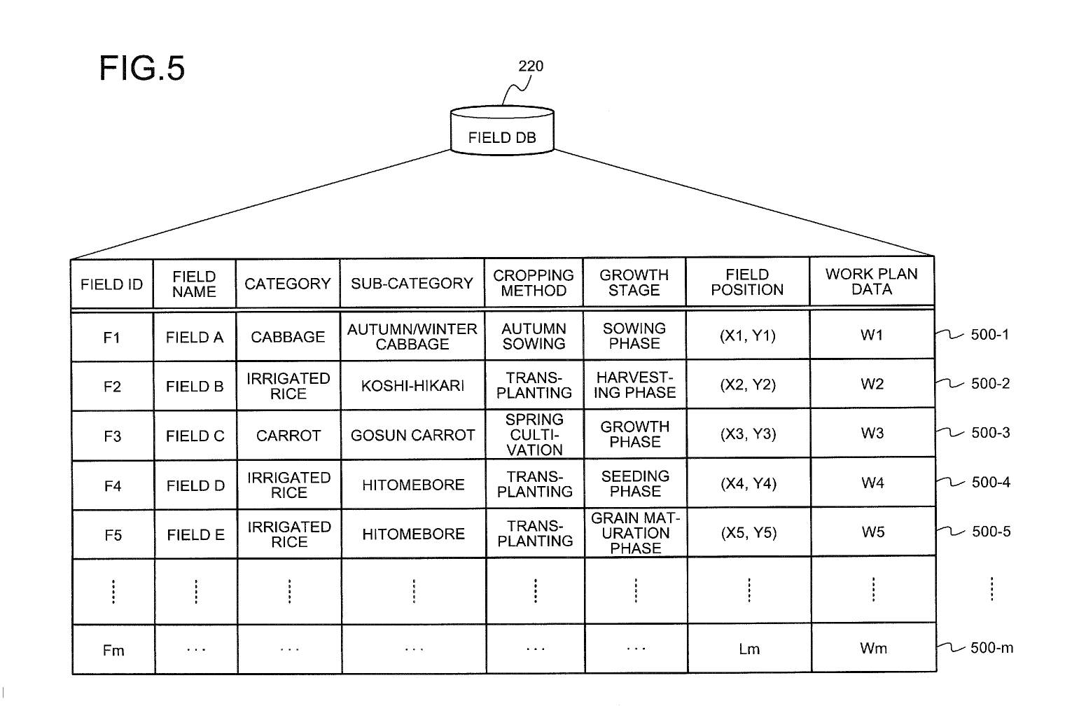

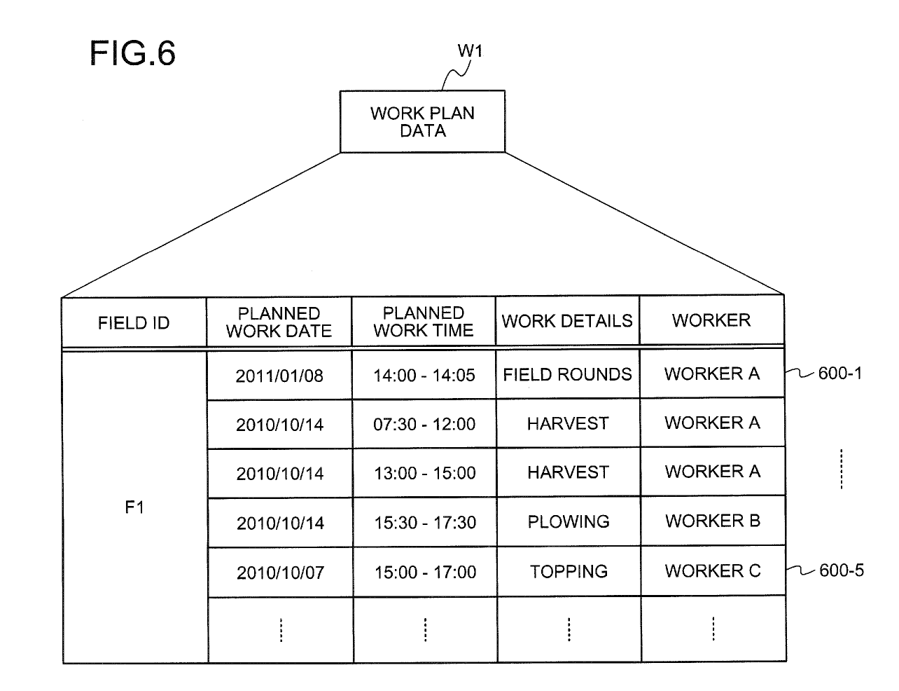

In this example, the information providing apparatus 201 includes a field database (DB) 220 and is a computer that provides information to the mobile device 101 of each worker W engaged in farm work. The contents of the field DB 220 will be described hereinafter with reference to FIGS. 5 and 6. Further, the information providing apparatus 201 collectively manages the images recorded by the mobile devices 101 used by the workers W. The information providing apparatus 201, for example, is installed at an office from which the workers W come and go.

FIG. 3 is a block diagram of an example of a hardware configuration of the mobile device according to the second embodiment. In FIG. 3, the mobile device 101 includes a central processing unit (CPU) 301, the memory 302, a camera 303, an interface (I/F) 304, an input device 305, and the display 110, respectively connected by a bus 300.

The CPU 301 governs overall control of the mobile device 101. The memory 302 includes read-only memory, (ROM), random access memory (RAM), and flash ROM. The ROM and the flash ROM, for example, store various types of programs such as boot program. The RAM is used as work area of the CPU 301.

The camera 303 records still images or moving images and outputs the recorded images as image data. Images recorded by the camera 303 are, for example, stored to the memory 302 as image data. The camera 303 may be an infrared camera that is capable of recording images at night.

The I/F 304 is connected to the network 210 via a communication line, and is connected to other apparatuses (e.g., the information providing apparatus 201) through the network 210. The I/F 304 administers an internal interface with the network 210 and controls the input and output of data with respect to external apparatuses.

The input device 305 performs the input of data. The input device 305, for example, may have keys for inputting letters, numerals, and various instructions and performs the input of data, or may be a touch-panel-type input pad or numeric keypad, etc.

The display 110 displays, for example, data such as text, images, functional information, etc., in addition to a cursor, icons, and/or tool boxes. The display 506 may be combined with the input device 305, which may be a touch-panel-type input pad or numeric keypad. A thin-film-transistor (TFT) liquid crystal display and the like may be employed as the display 110.

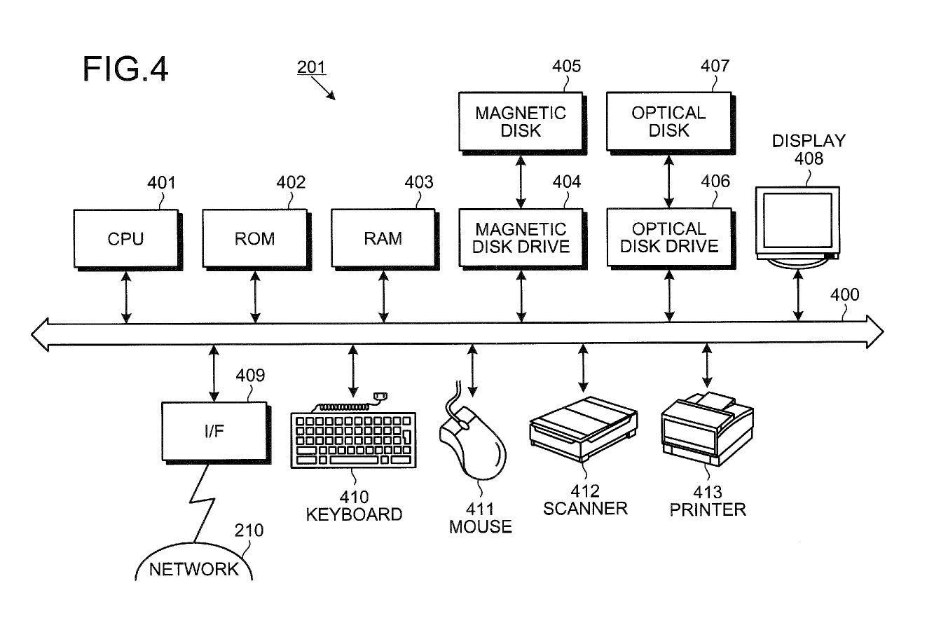

FIG. 4 is a block diagram of an example of a hardware configuration of the information providing apparatus according to the second embodiment. In FIG. 4, the information providing apparatus 201 includes a CPU 401, ROM 402, RAM 403, a magnetic disk drive 404, a magnetic disk 405, an optical disk drive 406, an optical disk 407, a display 408, an I/F 409, a keyboard 410, a mouse 411, a scanner 412, and a printer 413, respectively connected by a bus 400.

The CPU 401 governs overall control of the information providing apparatus 201. The ROM 402 stores programs such as a boot program. The RAM 403 is used as a work area of the CPU 401. The magnetic disk drive 404, under the control of the CPU 401, controls the reading and writing of data with respect to the magnetic disk 405. The magnetic disk 405 stores data written thereto under the control of the magnetic disk drive 404.

The optical disk drive 406, under the control of the CPU 401, controls the reading and writing of data with respect to the optical disk 407. The optical disk 407 stores data written thereto under the control of the optical disk drive 406, the data being read by a computer.

The display 408 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 408.

The I/F 409 is connected to the network 210 via a communication line, and is connected to other apparatuses (e.g., the mobile device 101) through the network 210. The I/F 409 administers an internal interface with the network 210, and controls the input and output of data with respect to external apparatuses. A modem or LAN adapter may be adopted as the I/F 409.

The keyboard 410 includes, for example, keys for inputting letters, numerals, and various instructions and performs the input of data. Alternatively, a touch-panel-type input pad or numeric keypad, etc. may be adopted. The mouse 411 is used to move the cursor, select a region, or move and change the size of windows. A track ball or a joy stick may be adopted provided each respectively has a function similar to a pointing device.

The scanner 412 optically reads images and takes in the image data into the information providing apparatus 201. The scanner 412 may have an optical character reader (OCR) function as well. Further, the printer 413 prints image data and text data. The printer 413 may be, for example, a laser printer or an ink jet printer. The configuration of the information providing apparatus 201 may omit the optical disk drive 406, the scanner 412, and the printer 413.

Next, the contents of the field DB 220 of the information providing apparatus 201 will be described. The field DB 220, for example, is implemented by a storage device such as the RAM 403, the magnetic disk 405, and the optical disk 407 of the information providing apparatus 201 depicted in FIG. 4.

FIG. 5 is a diagram depicting an example of the contents of the field DB. In FIG. 5, the field DB 220 has fields for field IDs, field names, categories, sub-categories, cropping methods, growth stages, field positions, and work plan data. By setting information into each of the fields, field data 500-1 to 500-m of the fields F1 to Fm are stored as records.

In this example, field IDs are identifiers of the fields F1 to Fm that are dispersed over various areas. Hereinafter, an arbitrary field among the fields F1 to Fm will be indicated as a “field Fj” (j=1, 2, . . . , m). The field name is the name of a field Fj. The category is the type of crop under cultivation in the field Fj. The category may be, for example, irrigated rice, cabbage, carrots, etc.

The sub-category is a type within a single category. For example, a sub-category may be koshi-hikari (rice), hitomebore (rice), autumn/winter cabbage (cabbage), winter cabbage (cabbage), spring cabbage (cabbage). The cropping method is a system indicating combinations of conditions and/or techniques when a crop is cultivated. The cropping method may be, for example, direct seeding, transplanting, spring cultivation, summer cultivation, autumn cultivation, and winter cultivation.

The growth stage is the stage of growth of the crop cultivated in the field Fj. The growth stage may be, for example, a sowing phase, a germination phase, a growth phase, a maturation phase, and a harvesting phase. The field position is information that indicates the position of the field Fj. In this example, the barycentric position of the field Fj mapped on a map is indicated as the field position. The map is drawing data expressing on an x-y coordinate plane, the group of fields F1 to Fm reduced in size by a constant rate. The work plan data is information indicating the work plan for farm work to be carried out in the field Fj. The work plan data will be described in detail hereinafter with reference to FIG. 6.

Taking the field data 500-1 as an example, the field name “field A” of the field F1, the category “cabbage”, the sub-category “autumn/winter cabbage”, the cropping method “autumn seeding”, the growth stage “sowing phase”, and the field position “X1, Y1” are indicated. Further, in the field data 500-1, a work plan data W1 is set. Here, taking the work plan data W1 for the field F1 as an example, work plan data Wj will be described.

FIG. 6 is a diagram depicting an example of work plan data. In FIG. 6, the work plan data W1 has fields for field IDs, planned work dates, planned work times, work details, and workers. By setting information into each of the fields, the work plan data (e.g., work plan data 600-1 to 600-5) are stored as records.

The field ID is the identifier of a field Fj. The planned work date is the date on which the farm work is planned to be performed in the field Fj. The planned work time is the time at which the farm work is planned to be performed in the field Fj. The work details are the details of the farm work that is to be performed in the field Fj. Work details may be, for example, weeding, making field rounds, topping root vegetables, plowing, permanent planting, fertilizer application, pesticide application, and harvesting. The worker is information that can uniquely identify the worker who will perform the farm work in the field Fj.

Taking the work plan data 600-1 as an example, the work details “field rounds” and the worker “worker A” concerning the planned farm work to be performed in the field F1 on the planned work date “2011/01/08” and the planned work time “14:00-14:05” are indicated.

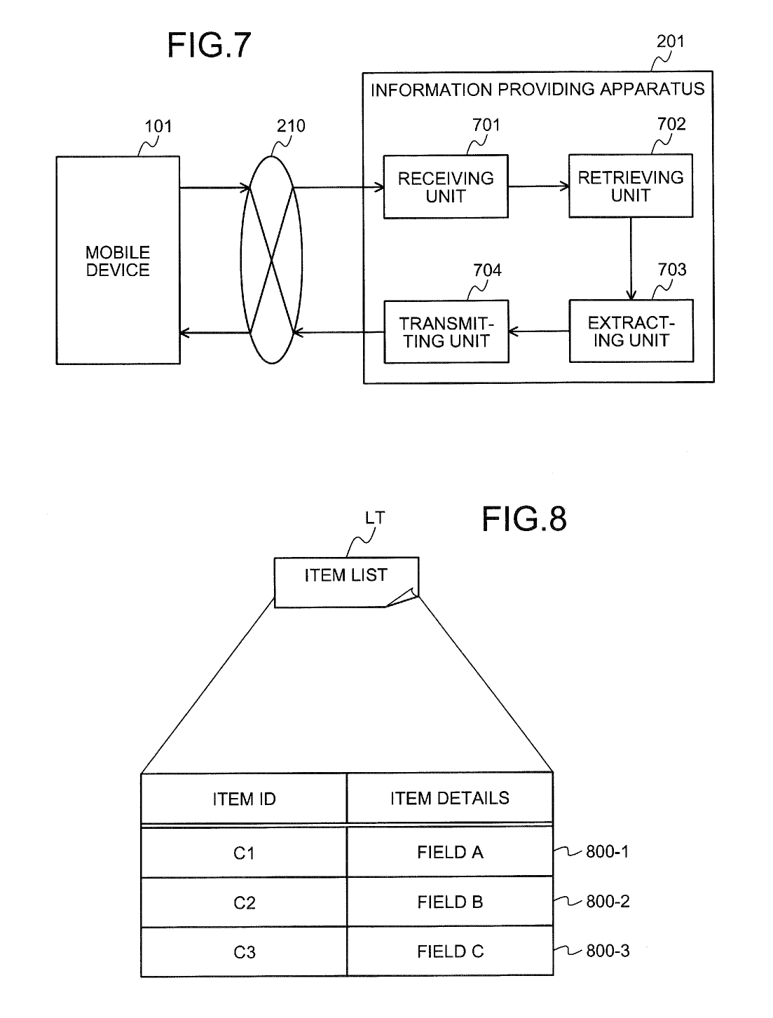

Next, an example of a functional configuration of the information providing apparatus 201 according to the second embodiment will be described. FIG. 7 is a block diagram of a functional configuration of the information providing apparatus according to the second embodiment. In FIG. 7, the information providing apparatus 201 includes a receiving unit 701, a retrieving unit 702, an extracting unit 703, and a transmitting unit 704. These functions (the receiving unit 701 to the transmitting unit 704) forming a control unit, for example, are implemented by executing on the CPU 401, a program stored in a storage device such as the ROM 402, the RAM 403, the magnetic disk 405, and the optical disk 407 depicted in FIG. 4, or via the I/F 409. Process results of the functional units, for example, are stored to a storage device such as the RAM 403, the magnetic disk 405, and the optical disk 407.

The receiving unit 701 has a function of receiving from the mobile device 101 used by a worker W, position information of the mobile device 101. Information indicating the time (e.g., the time and date) of receipt may be appended to the received position information of the mobile device 101, as a time stamp.

The retrieving unit 702 has a function of retrieving based on the field position L1 to Lm of the fields F1 to Fm in the field DB 220 and the received position information of the mobile device 101, a field Fj from among the fields F1 to Fm. For example, first, the retrieving unit 702 calculates distances d1 to dm between the coordinate position indicated by the position information of the mobile device 101 and each field position L1 to Lm of the fields F1 to Fm.

Then, the retrieving unit 702, for example, extracts from among the fields F1 to Fm, the field Fj for which the distance dj is shortest. Further, the retrieving unit 702 may retrieved from among the fields F1 to Fm, a field dj for which the distance dj is less than or equal to a given distance (e.g., 5 to 10 [m]). Further, the retrieving unit 702 may retrieve from among the fields F1 to Fm, fields (e.g., 3) having the shortest distances dj.

Thus, from among the fields F1 to Fm, a field Fj near the mobile device 101 can be identified. Hereinafter, a retrieved field Fj will be referred to as an “identified field F”.

The extracting unit 703 has a function of extracting from the field DB 220, information that characterizes the identified field F. For example, the extracting unit 703 extracts from the field DB 220, the field name of the identified field F. Extraction results are, for example, stored to an item list LT in a storage device.

The contents of the item list LT will be described. Here, a case where from among the fields F1 to Fm, the fields F1, F2, and F3 are retrieved as identified fields F will be described as an example.

FIG. 8 is a diagram of depicting an example of the contents of the item list (part 1). In FIG. 8, the item list LT has fields for item IDs and item details. By setting information into each of the fields, item data 800-1 to 800-3 are stored as records. Item IDs are identifiers of items.

In this example, the item data 800-1 indicates the item details “field A” of the item C1. The item data 800-2 indicates the item details “field B” of the item C2. The item data 800-3 indicates the item details “field C” of the item C3. On other words, the item details of each of the items C1 to C3 indicate the field names (field A, field B, field C) of the field F1 to F3 that are near the mobile device 101.

The transmitting unit 704 has a function of transmitting to the mobile device 101, information that characterizes the identified field F, as information representing an intended purpose of the person, who is engaged in the farm work and records an image of the identified field F. For example, the transmitting unit 704 transmits the item list LT depicted in FIG. 8 to the mobile device 101, thereby enabling the field name of the identified field F in the vicinity of the mobile device 101 to be provided to the mobile device 101 as information representing an intended purpose of the person.

The extracting unit 703 has a function of extracting from the field DB 220, information that characterizes the crop cultivated in the identified field F. For example, the extracting unit 703 extracts from the field DB 220, at least information concerning any among the category, the sub-category, and the cropping method of the crop cultivated in the identified field F. Extraction results, for example, are registered into the item list LT in a storage device.

The contents of the item list LT will be described. Here, as above, a case where from among the fields F1 to Fm, the fields F1, F2, and F3 are retrieved as identified fields F will be described as an example.

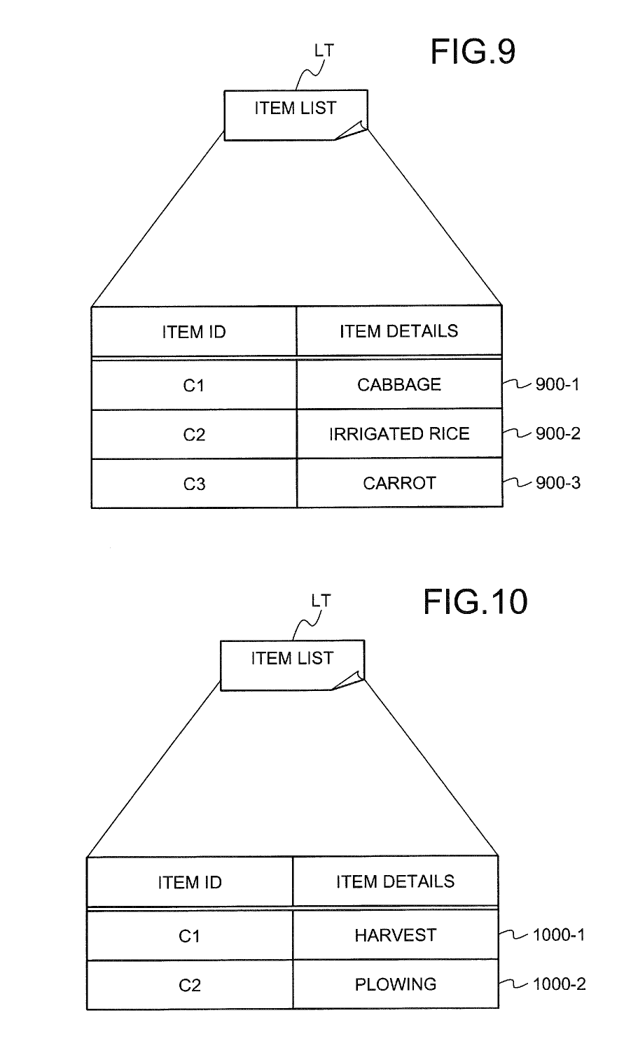

FIG. 9 is a diagram depicting an example of the contents the item list (part 2). In FIG. 9, the item list LT stores item data 900-1 to 900-3.

In this example, the item data 900-1 indicates the item details “cabbage” of the item C1. The item data 900-2 indicates the item details “irrigated rice” of the item C2. The item data 900-3 indicates the item details “carrot” of the item C3. In other words, the item details of each of the items C1 to C3 indicate the category (cabbage, irrigated rice, carrot) of the crop cultivated in the fields F1 to F3 that are near the mobile device 101.

The transmitting unit 704 has a function of transmitting to the mobile device 101, information that characterizes the crop cultivated in the identified field F, as information representing an intended purpose of the person engaged in the farm work. For example, the transmitting unit 704 transmits the item list LT depicted in FIG. 9 to the mobile device 101, thereby enabling the category of the crop cultivated in the identified field F that is near the mobile device 101 to be provided to the mobile device 101, as candidate information representing an intended purpose of the person.

The extracting unit 703 has a function of extracting from the field DB 220, information that characterizes the work details of the farm work performed in the identified field F. For example, the extracting unit 703 extracts from the field DB 220, the work details of the farm work planned to be performed in the identified field F on the date (or date and time) when the position information of the mobile device 101 is received.

Here, a case is assumed where the date when the position information of the mobile device 101 is received is “2010/10/14” and from among the fields F1 to Fm, the field F1 is retrieved as the identified field F. In this case, the extracting unit 703 extracts from the work plan data W1 depicted in FIG. 6, the work details “harvest” and “plowing” of the farm work to be performed in the field F1 on the planned work date “2010/10/14”. Extraction results, for example, are registered into the item list LT in a storage device.

FIG. 10 is a diagram depicting an example of the contents of the item list (part 3). In FIG. 10, the item list LT stores item data 1000-1 and 1000-2.

In this example, the item data 1000-1 indicates the item details “harvest” of the item C1. The item data 1000-2 indicates the item details “plowing” of the item C2. In other words, the item details of each of the items C1 and C2 indicate the work details (harvest, plowing) of the farm work performed in the field F1 that is in a vicinity of the mobile device 101.

The transmitting unit 704 has a function of transmitting to the mobile device 101, information that characterizes the work details of the farm work performed in the identified field F, as information representing an intended purpose of the person, who is engaged in the farm work and records an image of the identified field F. For example, the transmitting unit 704 transmits the item list LT depicted in FIG. 10 to the mobile device 101, thereby enabling the work details of the farm work planned to be performed in the identified field that is near the mobile device 101 to be provided to the mobile device 101, as candidate information representing an intended purpose of the person.

The extracting unit 703 has a function of extracting from a pest list that correlates and stores crops and harmful pests that are specific to the crops, information that characterizes pests specific to the crop cultivated in the identified field F. Here, the contents of the pest list will be described.

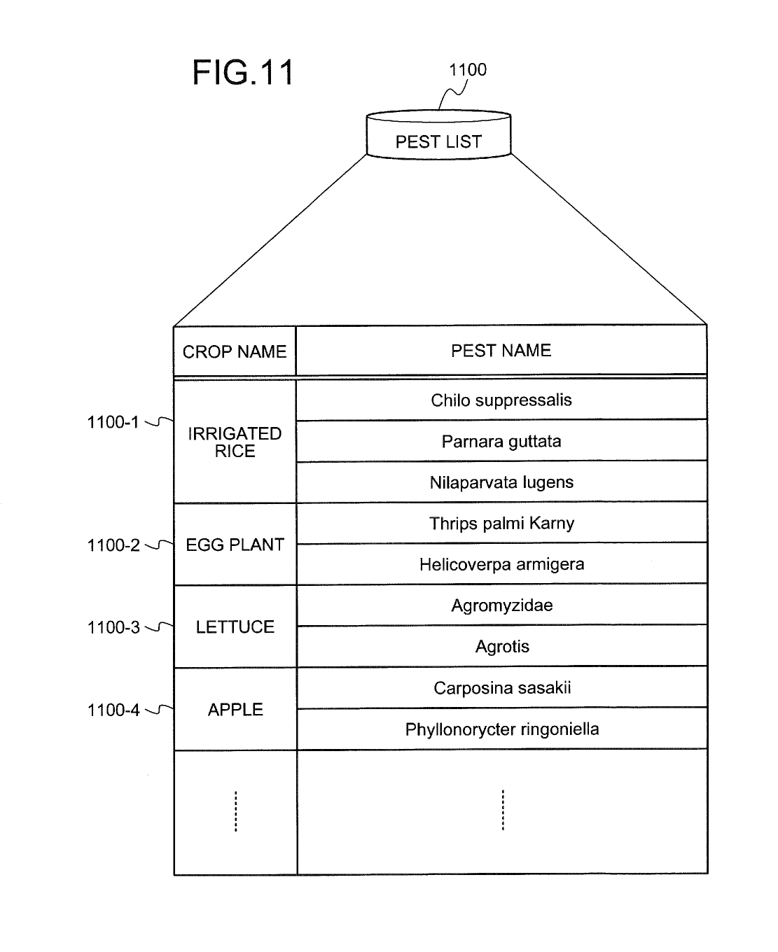

FIG. 11 is a diagram depicting an example of the contents of the pest list. In FIG. 11, a pest list 1100 includes fields for crop names and pest names. By setting information into each of the fields, pest data (e.g., pest data 1100-1 to 1100-4) are stored as records.

The crop name is the name (category) of the crop. The pest name is the name of a harmful pest specific to the crop. Taking the pest data 1100-1 as an example, the pest names “Chilo suppressalis”, “Parnara guttata”, and “Nilaparvata lugens” of harmful pests specific to the crop “irrigated rice” are indicated. Taking the pest data 1100-2 as an example, the pest names “Thrips palmi Karny” and “Helicoverpa armigera” of harmful pests specific to the crop “egg plant” are indicated. The pest list 1100, for example, is stored in a storage device such as the RAM 403, the magnetic disk 405, and the optical disk 407 of the information providing apparatus 201 depicted in FIG. 4.

Here, a case is assumed where from among the fields F1 to Fm, the field F2 is retrieved as the identified field F. In this case, the extracting unit 703 extracts from the pest list 1100, the pest names “Chilo suppressalis”, “Parnara guttata”, and “Nilaparvata lugens” of harmful pests specific to the crop “irrigated rice” cultivated in the field F2. Extraction results, for example, are registered into the item list LT in a storage device.

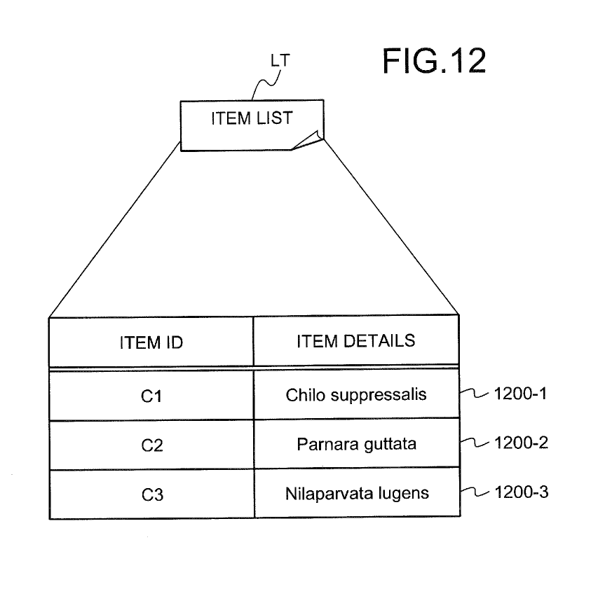

FIG. 12 is a diagram depicting an example of the contents of the item list (part 4). In FIG. 12, the item list LT stores item data 1200-1 to 1200-3. In this example, the item data 1200-1 indicates the item details “Chilo suppressalis” of the item C1. The item data 1200-2 indicates the item details “Parnara guttata” of the item C2.

The item data 1200-3 indicates the item details “Nilaparvata lugens” of the item C3. In other words, the item details of each of the item C1, C2, and C3 indicate the pests (Chilo suppressalis, Parnara guttata, and Nilaparvata lugens) specific to the crop cultivated in the field F2 that is near the mobile device 101.

The transmitting unit 704 has a function of transmitting to the mobile device 101, information that characterizes the pests specific to the crop cultivated in the identified field F, as candidate information representing an intended purpose of the person who is engaged in the farm work and records an image of the identified field F. For example, the transmitting unit 704 transmits the item list LT depicted in FIG. 12 to the mobile device 101, thereby enabling the names of pests specific to the crop cultivated in the identified field F that is near the mobile device 101 to be provided to the mobile device 101, as candidate information representing an intended purpose of the person.

The extracting unit 703 has a function of extracting from a disease list that correlates and stores the crops and harmful diseases specific to the crops, information that characterizes the diseases specific to the crop cultivated in the identified field F. Here, taking “irrigated rice” as the crop, the contents of the disease list will be described.

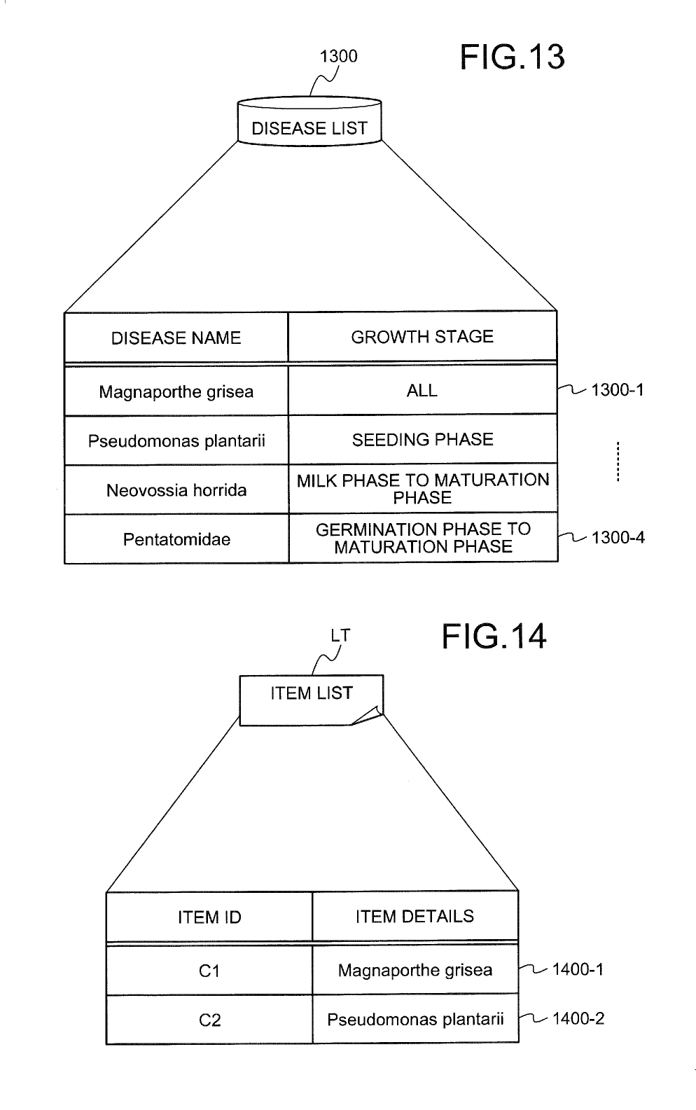

FIG. 13 is a diagram depicting the contents of the disease list. In FIG. 13, a disease list 1300 has fields for disease names and growth stages. By setting information into each of the fields, disease data (e.g., disease data 1300-1 to 1300-4) are stored as records.

The disease name is the name of a harmful disease specific to a crop (in this example, “irrigated rice”). The growth stage is a growth phase indicating a period when the disease occurs. Growth stages of “irrigated rice”, for example, are “seeding phase→germination phase→milk phase→kernel ripening phase→maturation phase→harvesting phase”.

Taking the disease data 1300-1 as an example, the name “Magnaporthe grisea” of a disease harmful to the crop “irrigated rice” and the growth stage “ALL” indicating the period when “Magnaporthe grisea” occurs are indicated. “ALL” indicates that the disease can occur at any of the growth stages.

Taking the disease data 1300-4 as an example, the name “stinkbug disease” a disease harmful to the crop “irrigated rice” and the growth stages “germination phase to maturation phase” indicating the period when “stinkbug disease” occurs are indicated. The disease list 1300, for example, is stored in a storage device such as the RAM 403, the magnetic disk 405, and the optical disk 407 of the information providing apparatus 201 depicted in FIG. 4.

Here, from among the fields F1 to Fm, the field F4 is assumed to be retrieved as the identified field F. In this example, the crop cultivated in the field F4 is “irrigated rice” and the growth stage “sowing phase”. In this case, the extracting unit 703 extracts from the disease list 1300, the disease names “Magnaporthe grisea” and “Pseudomonas plantarii” corresponding to the growth stage “sowing phase”. Extraction results, for example, are registered into the item list LT in a storage device.

FIG. 14 is a diagram depicting an example of the contents of the item list (part 5). In FIG. 14, the item list LT stores item data 1400-1 and 1400-2. In this example, the item data 1400-1 indicates the item details “Magnaporthe grisea” of the item C1. The item data 1400-2 indicates the item details “Pseudomonas plantarii” of the item C2. In other words, the item details of each of the items C1 and C2 indicate the names (Magnaporthe grisea, Pseudomonas plantarii) of diseases specific to the crop cultivated in the field F4 that is near the mobile device 101.

The transmitting unit 704 has a function of transmitting to the mobile device 101, information that characterizes diseases specific to the crop cultivated in the identified field F, as candidate information representing an intended purpose of the person who is engaged in the farm work and records an image of the identified field F. For example, the transmitting unit 704 transmits the item list LT depicted in FIG. 14 to the mobile device 101, thereby enabling the names of diseases of the crop cultivated in the identified field F that is near the mobile device 101 to be provided to the mobile device 101, as candidate information representing an intended purpose of the person.

The receiving unit 701 may receive from the mobile device 101, a worker ID of the worker W using the mobile device 101. Here, the worker ID is information uniquely identifying the worker W using the mobile device 101.

The extracting unit 703 may have a function of extracting from a work plan table, information characterizing the work details of the farm work performed by the worker W who is identified by the received worker ID. The work plan table is information that correlates and stores the worker ID of each worker W and the work details of the farm work planned to be performed by each of the workers W. Here, the contents of the work plan table will be described. The work plan table, for example, is stored in a storage device such as the RAM 403, the magnetic disk 405, and the optical disk 407.

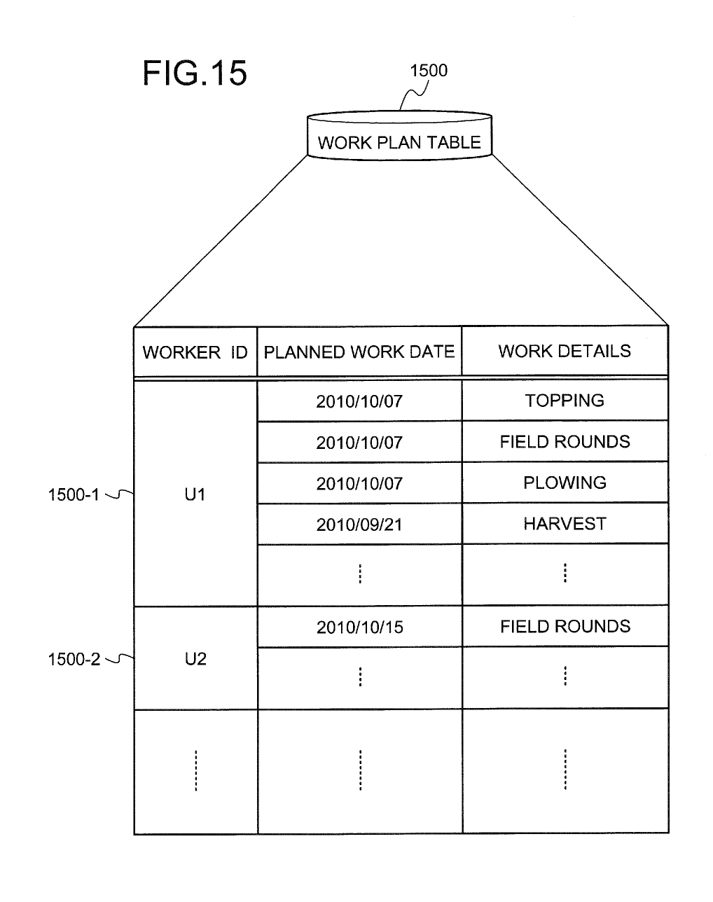

FIG. 15 is a diagram depicting an example of the contents of the work plan table. In FIG. 15, a work plan table 1500 stores a planned work list of each worker W (e.g., planned work lists 1500-1 and 1500-2). The worker ID is information uniquely identifying the worker W. The planned work date is the date on which the farm work is planned to be performed by the worker W. The work details are the work details of the farm work that is planned to be performed by the worker W.

The extracting unit 703 identifies in the work plan table 1500, the planned work list that corresponds to the received worker ID. Here, a case where the worker ID “U1” has been received is assumed. In this case, the extracting unit 703 identifies in the work plan table 1500, the planned work list 1500-1, which corresponds to the worker ID “U1”.

The extracting unit 703 extracts from the identified planned work list 1500-1, the work details of the farm work that is planned to be performed by the worker W on the date (or date and time) when the worker ID is received. In this example, the day when the worker ID “U1” is received is assumed to be “2010/10/07”. In this case, the extracting unit 703 extracts from the planned work list 1500-1, the work details “topping”, “field rounds”, and “plowing” of the farm work that is to be performed by the worker U1 on planned work date “2010/10/07”. Thus, the work details of the farm work to be performed by the worker W can be identified.

Detrimental conditions (e.g., frost, high temperatures, etc.) identified from meteorological information (temperature, humidity, amount of precipitation) for the received date, for example, can be used as candidate information representing an intended purpose of the person engaged in the farm work. Further, comments (e.g., poor germination rate, short plant height, etc.) indicating poor soil, poor crop growth, etc. in the identified field F may be used.

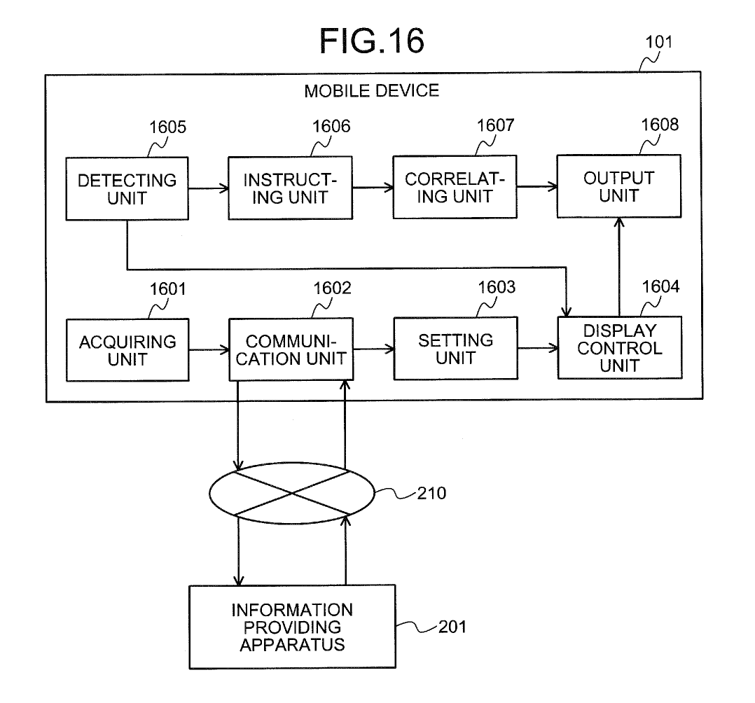

Next, an example of a functional configuration of the mobile device 101 according to the second embodiment will be described. FIG. 16 is a block diagram of a functional configuration of the mobile device according to the second embodiment. In FIG. 16, a given mobile device 101 includes an acquiring unit 1601, a communication unit 1602, a setting unit 1603, a display control unit 1604, a detecting unit 1605, an instructing unit 1606, a correlating unit 1607, and an output unit 1608. These functions (the acquiring unit 1601 to the output unit 1608), for example, are implemented by executing on the CPU 301, a program stored in the memory 302 depicted in FIG. 3, or by the I/F 304. Process results of each of the functions, for example, are stored to the memory 302.

The acquiring unit 1601 has a function of acquiring position information of the given mobile device 101. For example, the acquiring unit 1601 acquires the position information by a global positioning system (GPS) equipped on the given mobile device 101. In this case, the mobile device 101 may correct the position information acquired by the GPS using a differential GPS (DGPS).

The acquiring unit 1601 may receive from a communicating base station among wireless base stations that are dispersed over various areas, the position information of the base station and regard the received position information as that of the given mobile device 101. The position information acquiring process performed by the acquiring unit 1601 may be performed, for example, at constant intervals (e.g., 2-minute intervals) or may be performed when the camera 303 is activated.

The communication unit 1602 has a function of transmitting the acquired position information to the information providing apparatus 201. The position information transmitting process performed by the communication unit 1602 may be performed, for example, at constant intervals (e.g., 2-minute intervals) or may be performed when the camera 303 is activated. Further, the communication unit 1602 has a function of transmitting to the information providing apparatus 201, the worker ID of the worker W using the given mobile device 101.

The communication unit 1602 has a function of receiving from the information providing apparatus 201, item data consequent to transmitting the position information (or the worker ID of the worker W). Here, the item data is information representing an intended purpose of the person engaged in the farm work. For example, the communication unit 1602 receives the item list LT (for example, refer to FIGS. 8 to 10, FIG. 12, and FIG. 14) from the information providing apparatus 201.

The setting unit 1603 has a function of setting the item details of items representing an intended purpose of the person engaged in the farm work. For example, based on the received item list LT, the setting unit 1603 sets the item details of items representing an intended purpose of the person engaged in the farm work.

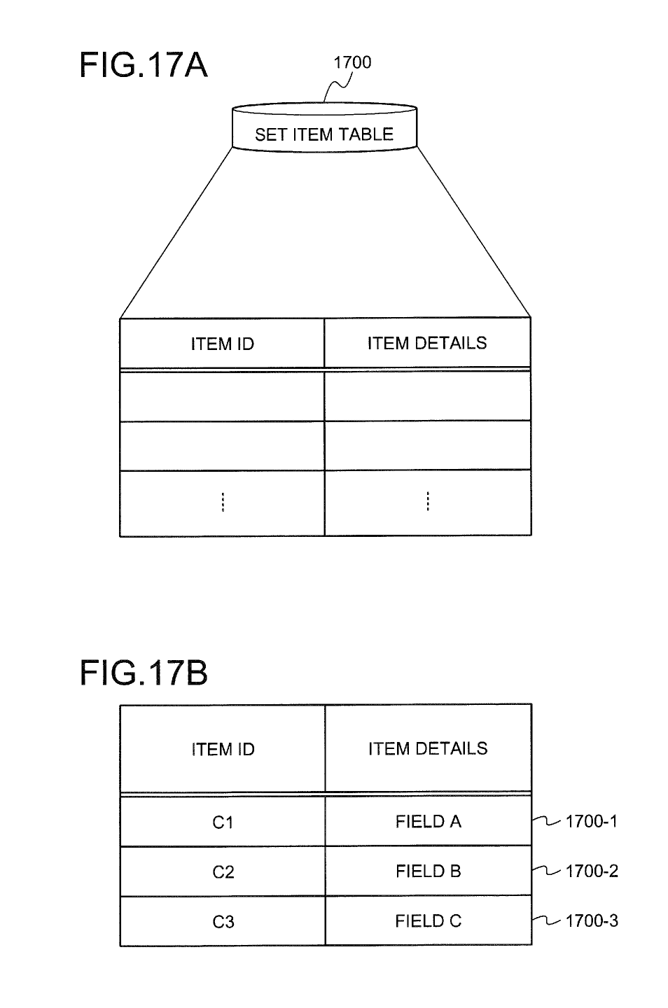

Taking the item list LT depicted in FIG. 8 as an example, for the items C1, C2 and C3, the setting unit 1603 sets the item details “field A”, “field B” and “field C”, respectively. Setting results, for example, are stored to a set item table 1700 depicted in FIGS. 17A and 17B. The set item table 1700, for example, is implemented by the memory 302. Here, the set item table 1700 will be described.

FIGS. 17A and 17B are diagrams depicting an example of the contents of the set item table. In FIGS. 17A and 17B, the set item table 1700 includes fields for item IDs and item details. By setting information into each of the fields, set item data are stored as records.

In FIG. 17A, no information has been set in the item ID field or the item details field in the set item table 1700. Here, the item list LT depicted in FIG. 8 is assumed to be received from the information providing apparatus 201 by the communication unit 1602.

In FIG. 17B, consequent to setting information into the item ID fields and the item details fields, set item data 1700-1 to 1700-3 are stored as records. In this example, the set item data 1700-1 indicates the item details “field A” for the item C1. The set item data 1700-2 indicates the item details “field B” for the item C2. The set item data 1700-3 indicates the item details “field C” for the item C3.

Thus, the field names of identified fields F that are near the given mobile device 101 can be set as the item details of items representing an intended purpose of the person engaged in the farm work. In the description hereinafter, a group of items representing an intended purpose of the person engaged in the farm work will be indicated as a “group of items C1 to Cn” and an arbitrary item among the group of items C1 to Cn will be indicated as “Ci” (i=1, 2, . . . , n).

The reference of the description returns to FIG. 16. The display control unit 1604 controls the display 110 and displays the item details of each of the items Ci of the group of items C1 to Cn. For example, when the camera 303 is activated, the display control unit 1604 refers to the set item table 1700 depicted in FIG. 17 and displays the item details “field A”, “field B”, and “field C” of the items C1 to C3 on the display 110 (finder screen).

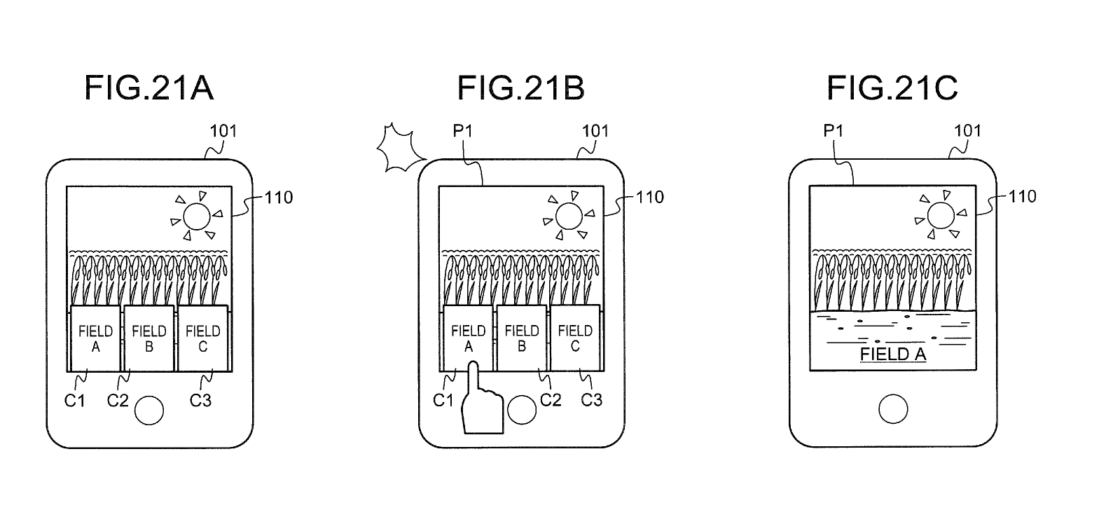

Here, the display control unit 1604 may display the item details of the items C1 to C3 to be superimposed on the subject on the finder screen displayed on the display 110. Further, the layout and design when the item details of the items C1 to C3 are displayed on the display 110 can be set arbitrarily. Examples of screens displayed on the display 110 will be described hereinafter with reference to FIG. 21A to FIG. 24C.

The detecting unit 1605 has a function of detecting an input operation selecting an item Ci from among the group of items C1 to Cn. An input operation selecting an item Ci is, for example, an input operation performed by the user using the input device 305 depicted in FIG. 3.

For example, the detecting unit 1605 may detect a touching of the item details of any one of the items Ci among the group of items C1 to Cn on the display 110 by the user, as a selection input selecting the item Ci of the item details touched. Further, the detecting unit 1605 may, for example, detect a pressing (by the user) of any one button among buttons on the mobile device 101, respectively corresponding to the items Ci as a selection input selecting the item Ci corresponding to the pressed button. Correspondences between the buttons of the mobile device 101 and each of the items Ci, for example, are preliminarily set and stored to the memory 302.

The instructing unit 1606 has a function of outputting a record instruction to the camera 303 when an input operation selecting an item Ci has been detected. The camera 303, upon receiving the record instruction from the instructing unit 1606, records the subject. In other words, upon an input operation selecting an item Ci, i.e., “shutter button” manipulation, recording by the camera 303 is performed.

The correlating unit 1607 has a function of correlating the image recorded by the camera 303 and the selected item Ci consequent to the output of the record instruction. For example, the correlating unit 1607 may correlate the image of the camera 303 and the item details of the selected item Ci.

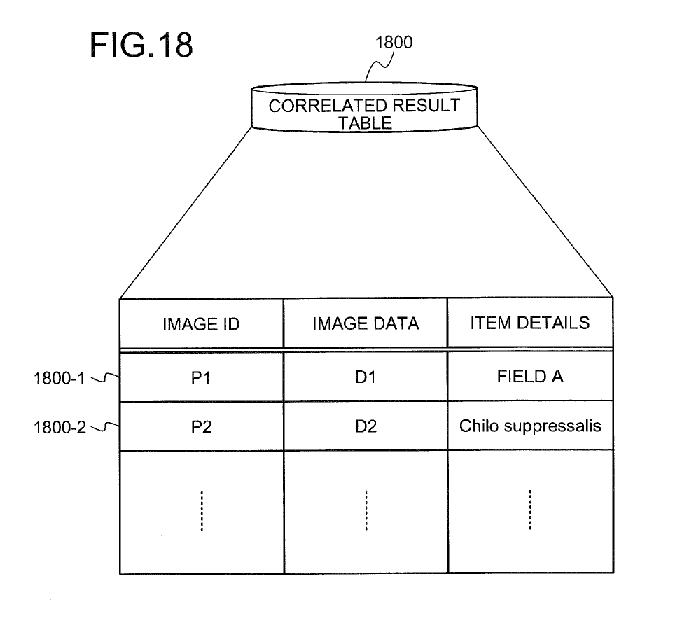

Correlated results, for example, are stored to a correlated result table 1800 depicted in FIG. 18. The correlated result table 1800, for example, is implemented by the memory 302. Here, the correlated result table 1800 will be described.

FIG. 18 is a diagram depicting the contents of the correlated result table 1800. In FIG. 18, the correlated result table 1800 includes fields for image IDs, image data, and item details. By setting information into each of the fields, correlated results (e.g., correlated results 1800-1 and 1800-2) are stored as records.

The image ID is an identifier of an image recorded by the camera 303. The image data is the image data of the image recorded by the camera 303. The item details are the item details of items that are correlated with the image and represent an intended purpose.

In this example, the correlated result 1800-1 indicates the correlation of image data D1 of an image P1 and the item details “field A” of an item representing an intended purpose. Further, the correlated result 1800-2 indicates the correlation of image data D2 of an image P2 and the item details “Chilo suppressalis” of an item representing an intended purpose.

The reference of description returns to FIG. 16, the output unit 1608 has a function of outputting correlated results. For example, the output unit 1608 may refer to the correlated result table 1800 depicted in FIG. 18 and display on the display 110 an image and the item details of an item Ci that are correlated. The name of the worker W using the mobile device 101, the time of recording, etc. may be appended to the image.

The form output, for example, may be display on the display 110, print out at the printer 413, and transmission via the I/F 409 to an external apparatus (e.g., the information providing apparatus 201). Further, output may be storage to a storage device such as the RAM 403, the magnetic disk 405, and the optical disk 407.

Although the setting unit 1603 is described to set based on the received item list LT, the item details of an item Ci representing an intended purpose of the person engaged in the farm work, configuration is not limited hereto. For example, the item details of the item Ci representing an intended purpose may be preliminarily set and stored in the set item table 1700.

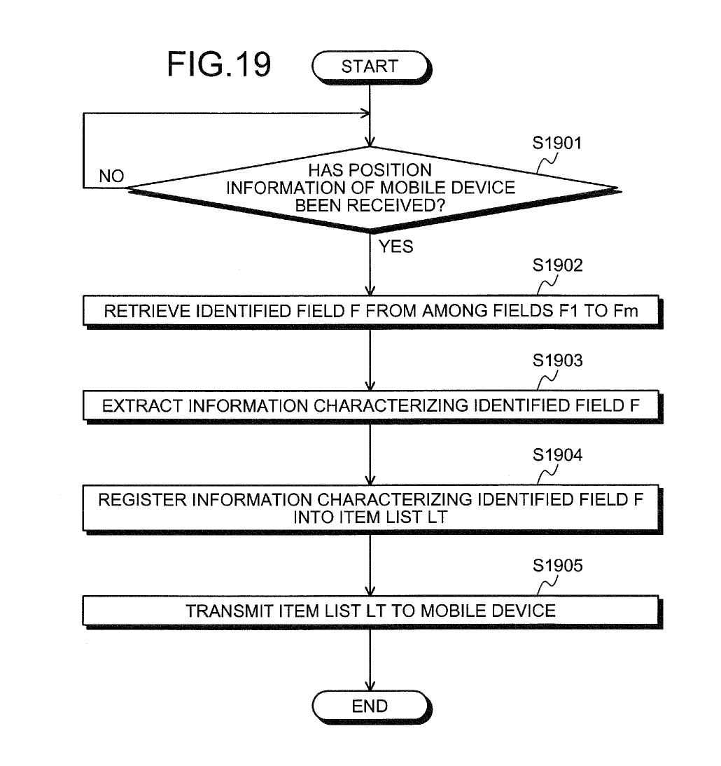

Next, a procedure of an information providing process performed by the information providing apparatus 201 according to the second embodiment will be described. FIG. 19 is a flowchart of a procedure of the information providing process by the information providing apparatus according to the second embodiment. In the flowchart depicted in FIG. 19, the receiving unit 701 determines whether position information of a mobile device 101 has been received from the mobile device 101 used by a worker W (step S1901).

Here, the receiving unit 701 awaits receipt of position information of a mobile device 101 (step S1901: NO). When position information of a mobile device 101 has been received (step S1901: YES), the retrieving unit 702, based on the field positions L1 to Lm of the fields F1 to Fm and the position information of the mobile device 101, retrieves an identified field F from among the fields F1 to Fm (step S1902).

The extracting unit 703 extracts from the field DB 220, information characterizing the identified field F (step S1903), and registers the information characterizing the identified field F into the item list LT (step S1904). The transmitting unit 704 transmits the item list LT to the mobile device 101 (step S1905), ending a series of operations according to the present flowchart.

Thus, information characterizing the identified field F that is near the mobile device 101 can be provided to the mobile device 101 as information representing an intended purpose.

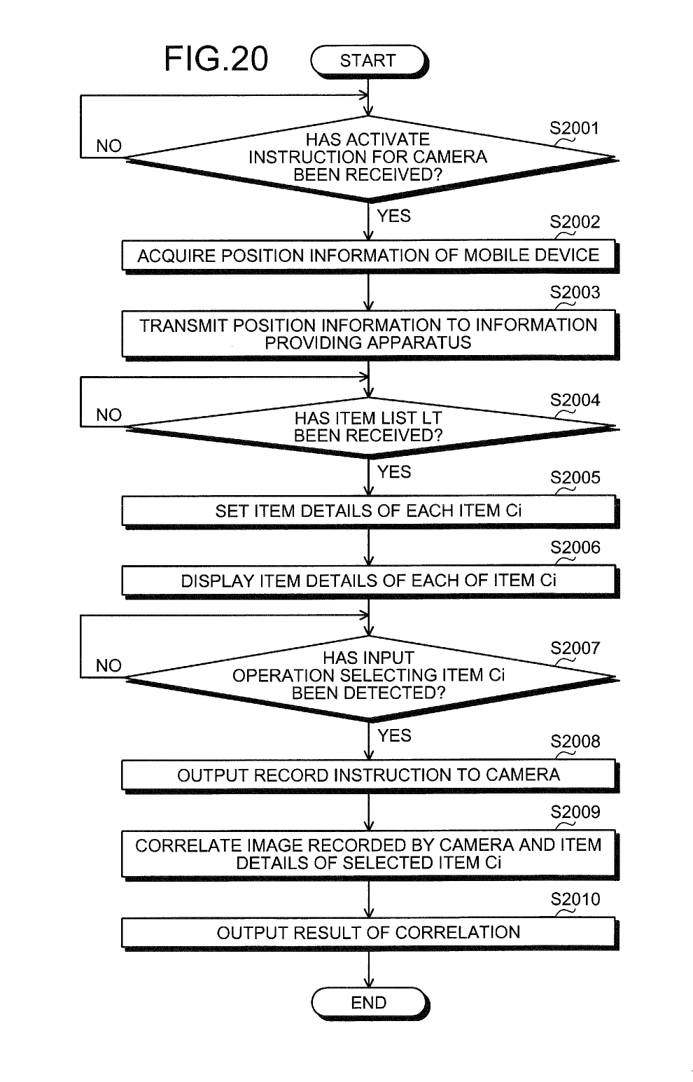

Next, a procedure of the work support process performed by the mobile device 101 according to the second embodiment will be described. FIG. 20 is a flowchart of a procedure of the work support process performed by the mobile device according to the second embodiment.

In FIG. 20, the mobile device 101 determines whether an activate instruction for the camera 303 has been received (step S2001). An activate instruction of the camera 303, for example, is performed by a user input operation via the input device 305 depicted in FIG. 3.

Here, the mobile device 101 awaits receipt of an activate instruction for the camera 303 (step S2001: NO). When an activate instruction has been received (step S2001: YES), the acquiring unit 1601 acquires the position information of the mobile device 101 (step S2002).

The communication unit 1602 transmits the acquired position information to the information providing apparatus 201 (step S2003), and determines whether the item list LT has been received from the information providing apparatus 201 (step S2004).

Here, the mobile device 101 awaits receipt of the item list LT by the communication unit 1602 (step S2004: NO). When the item list LT has been received (step S2004: YES), the setting unit 1603, based on the item list LT, sets the item details of each item Ci among the group of items C1 to Cn (step S2005). Setting results are stored to the set item table 1700 depicted in FIG. 17.

The display control unit 1604 refers to the set item table 1700 and displays on the display 110, the item details of each of the items Ci among the group of items C1 to Cn (step S2006). The mobile device 101 determines whether an input operation selecting an item Ci among the group of items C1 to Cn has been detected by the detecting unit 1605 (step S2007).

Here, the mobile device 101 awaits detection of an input operation selecting an item Ci by the detecting unit 1605 (step S2007: NO). When an input operation has been detected (step S2007: YES), the instructing unit 1606 outputs a record instruction to the camera 303 (step S2008).

The correlating unit 1607 correlates the image recorded by the camera 303 and the item details of the selected item Ci (step S2009). The output unit 1608 outputs the result of the correlation (step S2010), ending a series of operations according to the present flowchart.

Thus, an image recorded by the camera 303 and item details of an item Ci representing an intended purpose can be correlated and output.

Next, screen examples of the display 110 of the mobile device 101 will be described. Here, first, a case where the item list LT depicted in FIG. 8 is received from the information providing apparatus 201 by the communication unit 1602 will be described as an example.

FIGS. 21A, 21B, and 21C are diagrams depicting examples of screens displayed on the display of the mobile device according to the second embodiment (part 1). In FIG. 21A, the subject and the item details “field A”, “field B”, and “field C” of the items C1 to C3 are displayed on the display 110 of the mobile device 101.

In this example, “field A”, “field B”, and “field C” are the field names of the identified fields F that are near the mobile device 101. In other words, “field A”, “field B”, and “field C” represent candidates of the object (fields) that may have motivated the recording of the image by the worker W using the mobile device 101.

Here, the field name of the field shown on the display 110 is assumed to be “field A” and the worker W using the mobile device 101 is assumed to record an image of the field to report field rounds. In this case, the item representing the intended purpose of the worker W is the item C1, which represents the field name “field A” of the field that is to be the subject to be recorded.

In FIG. 21B, consequent to the detection of an input operation selecting the item C1, the image P1 is recorded by the camera 303. In other words, consequent to a selection of the item C1, which represents the intended purpose of the worker W using the mobile device 101, the image P1 is recorded by the camera 303.

In FIG. 21C, the image P1 recorded by the camera 303 and the item details “field A” of the item C1 representing the intended purpose of the worker W are correlated and displayed on the display 110.

Thus, the mobile device 101 enables the image P1 and the intended purpose of the worker W to be correlated and output, consequent to the worker W selecting the field name “field A” that corresponds to the purpose of recording the image P1, from among the field names “field A, B, and C” of fields that may have motivated the recording of the image P2.

Next, a case where the item list LT depicted in FIG. 10 is received from the information providing apparatus 201 by the communication unit 1602 will be described as an example.

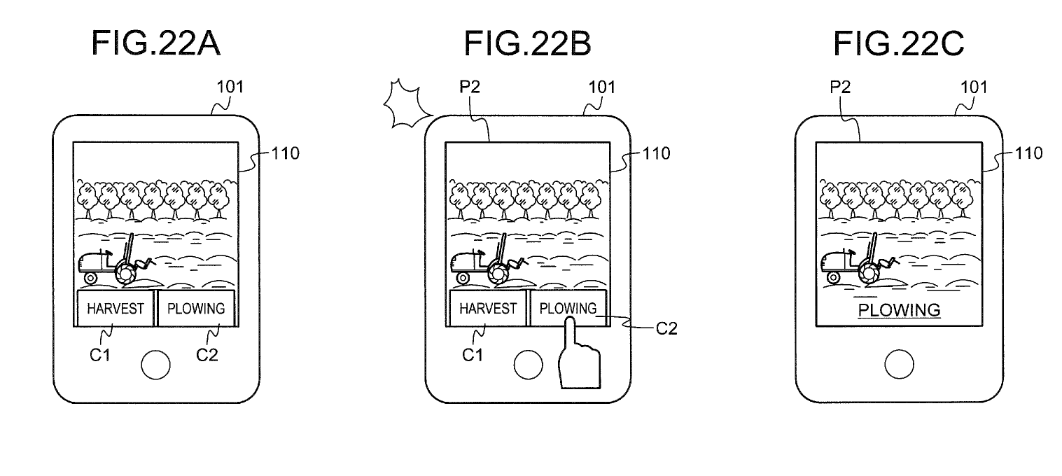

FIGS. 22A, 22B, and 22C are diagrams depicting examples of screens displayed on the display of the mobile device according to the second embodiment (part 2). In FIG. 22A, the subject and the item details “harvest” and “plowing” of the items C1 and C2 are displayed on the display 110 of the mobile device 101.

Here, “harvest” and “plowing” are the work details of the farm work performed in the identified field F that is near the mobile device 101. In other words, “harvest” and “plowing” represent candidates of an event (farm work) that may have motivated the recording of the image by the worker W using the mobile device 101.

Here, the worker W using the mobile device 101 is assumed to record an image of the field to report the implementation of plowing work. In this case, the item representing the intended purpose of worker W is the item C2, which represents the work details “plowing” of the farm work.

In FIG. 22B, consequent to the detection of an input operation selecting the item C2, the image P2 is recorded by the camera 303. In other words, consequent to a selection of the item C2, which represents the intended purpose of the worker W using the mobile device 101, the image P2 is recorded by the camera 303.

In FIG. 22C, the image P2 recorded by the camera 303 and the item details “plowing” of the item C2 representing the intended purpose of the worker W using the mobile device 101 are correlated and displayed on the display 110.

Thus, the mobile device 101 enables the image P2 and the intended purpose of the worker W to be correlated and displayed, consequent to the worker W selecting the work details “plowing” that correspond to the purpose of recording the image P2, from among the work details “harvest and plowing” that may have motivated the recording of the image P2.

Next, a case where the item list LT depicted in FIG. 12 is received from the information providing apparatus 201 by the communication unit 1602 will be described as an example.

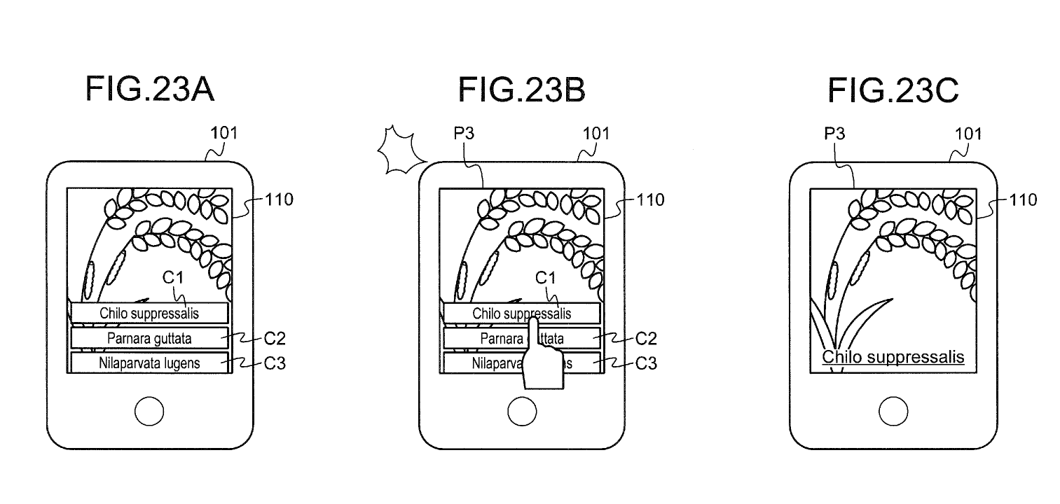

FIGS. 23A, 23B, and 23C are diagrams depicting examples of screens displayed on the display of the mobile device according to the second embodiment (part 3). In FIG. 23A, the subject and the item details “Chilo suppressalis”, “Parnara guttata”, and “Nilaparvata lugens” of the items C1 to C3 are displayed on the display 110 of the mobile device 101.

Here, “Chilo suppressalis”, “Parnara guttata”, and “Nilaparvata lugens” are the names of pests specific to the crop cultivated in the identified field F that is near the mobile device 101. In other words, “Chilo suppressalis”, “Parnara guttata”, and “Nilaparvata lugens” represent candidates of an event (occurrence of pests) that may have motivated the recording of the image by the worker W using the mobile device 101.

Here, the worker W using the mobile device 101 is assumed to record an image of the field to report the occurrence of Chilo suppressalis (larva) on the irrigated rice. In this case, the item representing the intended purpose of the worker W is the item C1, which represents the pest name “Chilo suppressalis”.

In FIG. 23B, consequent to the detection of an input operation selecting the item C1, an image P3 is recorded by the camera 303. In other words, consequent to a selection of the item C1, the image P3 is recorded by the camera 303.

In FIG. 23C, the image P3 recorded by the camera 303 and the item details “Chilo suppressalis” of the item C1, which represents the intended purpose of the worker W using the mobile device 101, are correlated and displayed on the display 110.

Thus, the mobile device 101 enables the image P3 and the intended purpose of the worker W to be correlated and output, consequent to the worker W selecting the pest name “Chilo suppressalis” that corresponds to the purpose of recording the image P3, from among the pest names “Chilo suppressalis, Parnara guttata, and Nilaparvata lugens” that may have motivated the recording the image P3.

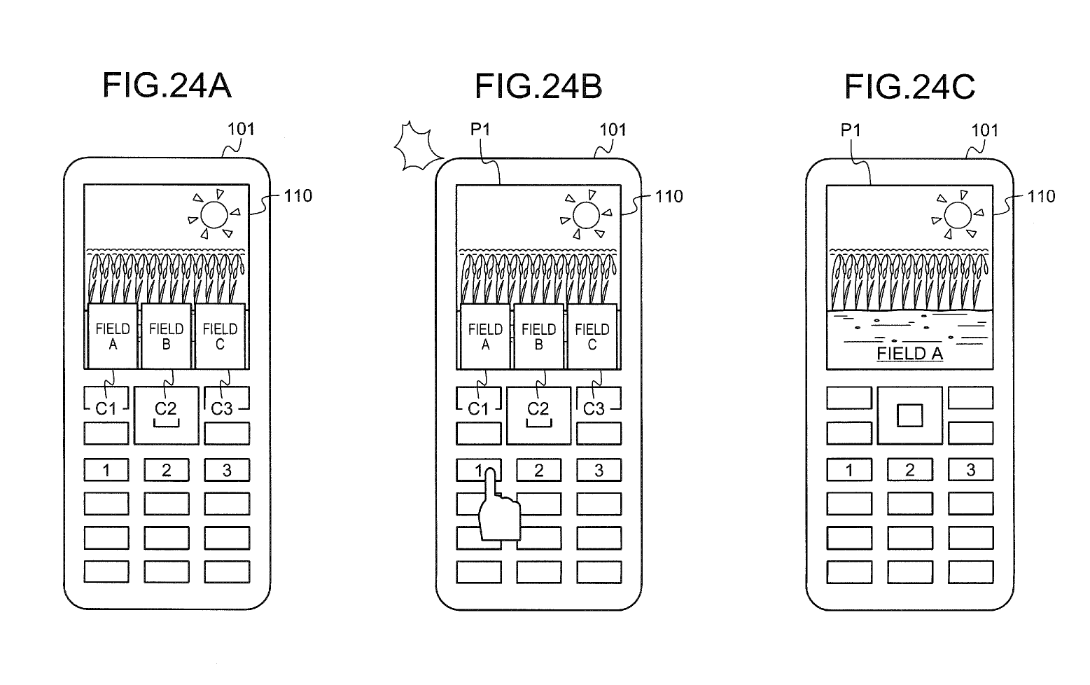

In FIGS. 21A to 23C, although an example where, as options (item details of item Ci) are output as soft keys on the display 110, the means of output is not limited hereto. For example, another example when options identical to those in to FIGS. 21A to 23C are output is depicted in FIGS. 24A, 24B, and 24C.

FIGS. 24A, 24B, and 24C are diagrams depicting examples of screens displayed on the display of the mobile device according to the second embodiment (part 4). In FIGS. 24A, 24B, and 24C, the detecting unit 1605 preliminarily stores correspondences between the items Ci and the buttons of the mobile device 101. Further, the detection of a pressing (by the user) of a button among the buttons respectively corresponding to the items Ci, indicates an example of detection of a selection input of selecting the item Ci that corresponds to the pressed button.

In FIG. 24A, for example, the items C1, C2, and C3 are respectively correlated with the buttons “1”, “2”, and “3” of the mobile device 101.

In FIG. 24B, consequent to the detection of an input operation selecting the item C1, in other words, a pressing of button “1”, the image P1 is recorded by the camera 303. In other words, consequent to the worker W using the mobile device 101 selecting the item C1, which represent the intended purpose of the worker W, the image P1 is recorded by the camera 303.

In FIG. 24C, the image P1 recorded by the camera 303 and the item details “field A” of the item C1 representing the intended purpose of the worker W using the mobile device 101 are correlated and displayed on the display 110.

Next, an example a screen displayed on the display 408 of the information providing apparatus 201 will be described. Here, a case where, in the information providing apparatus 201, the images P1 to P3 collected from multiple mobile devices 101 are collectively displayed on the display 408 will be described as a screen example.

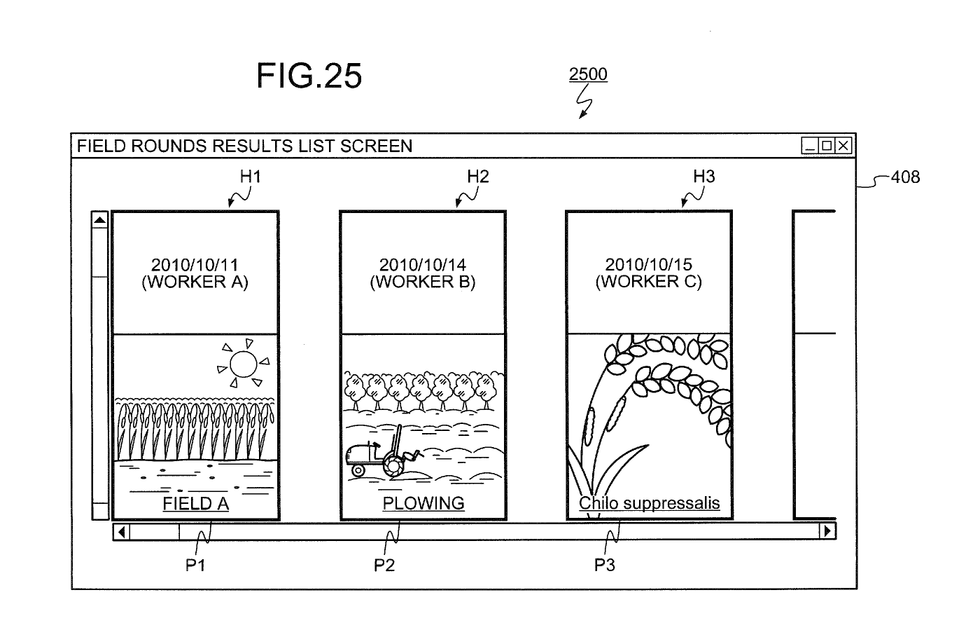

FIG. 25 is a diagram depicting an example of a screen displayed on the display of the information providing apparatus according to the second embodiment. In FIG. 25, a field rounds results list screen 2500 that includes display data H1 to H3 related to the images P1 to P3 recorded by the mobile devices 101 is displayed on the display 408.

In the display data H1, the item details “field A” of the item that represents the intended purpose of the worker A with respect to the image P1 is displayed. In the display data H2, the item details “plowing” of the item that represents the intended purpose of the worker B with respect to the image P2 is displayed. In the display data H3, the item details “Chilo suppressalis” of the item that represent the intended purpose of the worker C with respect to the image P3 is displayed.

Since the images P1 to P3 and the item details of the items representing the intended purposes of the workers A to C are displayed, the field rounds results list screen 2500 enables a person viewing the images P1 to P3 to easily determine the intended purpose of the workers A to C, who recorded the images P1 to P3. As a result, the state of the fields, the growth state of the crops, an occurrence of disease and/or pests, etc. can be quickly grasped.

For example, an occurrence of pests in a field can be quickly understood, by the viewer checking the image P3 and the pest “Chilo suppressalis” that are displayed together. Further, a pesticide (e.g., liner-feed, flowable pesticide; romdanzol (tebufenozide wettable powder)) necessary in exterminating the pest can be identified from the pest name “Chilo suppressalis”, enabling quick and proper countermeasures to be taken.

In the description above, although the mobile device 101 has been described to refer to the item list LT obtained from the information providing apparatus 201 and set the item details of items Ci representing intended purposes, configuration is not limited hereto. For example, the mobile device 101 may identify information candidates that represent the intended purpose of the person engaged in the farm work and set the item details for the items Ci. In other words, the mobile device 101 may be configured to include the field DB 220 and to have a functional unit corresponding to the retrieving unit 702 and the extracting unit 703 of the information providing apparatus 201.

As described, the mobile device 101 according to the second embodiment can set the field name of an identified field F that is near the mobile device 101, as the item details of an item that represents an intended purpose of a person engaged in farm work, thereby enabling an image and an object (field) that may have motivated the recording of the image to be easily correlated.

The mobile device 101 and the information providing apparatus 201 according to the second embodiment can set the category of a crop cultivated in an identified field F that is near the mobile device 101, as the item details of an item that represents an intended purpose of a person engaged in farm work, thereby enabling an image and an object (crop) that may have motivated the recording of the image to be easily correlated.

The mobile device 101 and the information providing apparatus 201 according to the second embodiment can set the work details of farm work that is planned to be performed in an identified field F that is near the mobile device 101, as the item details of an item that represents an intended purpose of a person engaged in the farm work thereby, enabling an image and an event (farm work) that may have motivated the recording of the image to be easily correlated.

The mobile device 101 and the information providing apparatus 201 according to the second embodiment can set the names of pests specific to a crop cultivated in an identified field F that is near the mobile device 101, as the item details of an item that represents an intended purpose of a person engaged in the farm work, thereby enabling an image and an event (occurrence of pests) that may have motivated the recording of the image to be easily correlated.

The mobile device 101 and the information providing apparatus 201 according to the second embodiment can set the names of diseases specific to a crop cultivated in an identified field F that is near the mobile device 101, as the item details of an item that represents an intended purpose of a person engaged in the farm work, thereby enabling an image and an event (occurrence of disease) that may have motivated the recording of the image to be easily correlated.

In a third embodiment, a case will be described where items representing an intended purpose of the worker W using the mobile device 101 are narrowed down interactively. Hereinafter, process contents of functional units of the mobile device 101 according to the third embodiment will be described. Description of aspects identical to those of the first and the second embodiments will be omitted hereinafter.

A tiered tree-structure of the items Ci (as nodes) of the group of items representing intended purposes of a person engaged in farm work will be described. Information related to the tiered tree-structure, for example, is stored in the memory 302 of the mobile device 101 depicted in FIG. 3.

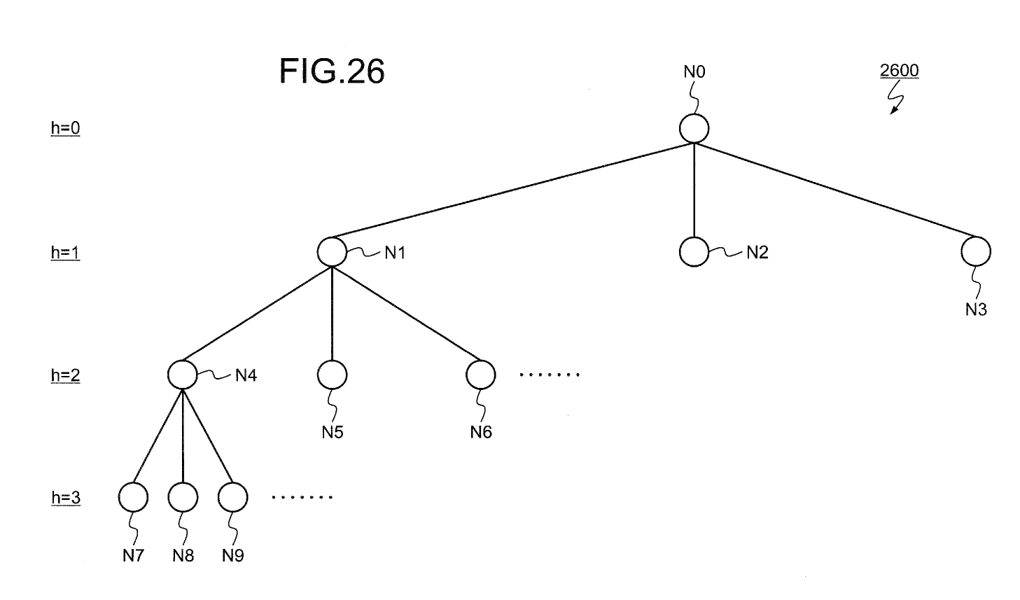

FIG. 26 is a diagram depicting an example of the tree-structure. In FIG. 26, a tree-structure 2600 includes nodes N1 to Nn that represent the items C1 to Cn, which represent intended purposes of a person engaged in the farm work. In FIG. 26, “h” represents tiers in the tree-structure 2600. In the figure, the tree-structure 2600 is depicted omitting a portion thereof.

In this example, the node N0 is a root node that does not represent any item. The root node is a node that has no parent node. The nodes N1 to N3 are child nodes of the node N0 and represent the items C1 to C3. The nodes N4 to N6 are child nodes of the node N1 and represent the items C4 to C6. The nodes N7 to N9 are child nodes of the node N4 and represent the items C7 to C9.

The item details of the items Ci represented by the nodes Ni included in the tree-structure 2600 are preliminarily set (i=1, 2, . . . , n). For example, in the tree-structure 2600, the item details of items represented by child nodes are set to be the details of the item details of the items that are represented by parent nodes. For example, if the item details of the item C1 represented by the node N1 is “pests and disease”, the item details of the items C4 to C6 represented by the child nodes N4 to N6 of the node N1 are the specific names of pests and diseases (disease names, pest names).

The display control unit 1604 displays on the display 110, the item details of the items that are represented by the nodes belonging to a tier h (where, h≠0) in the tree-structure 2600. For example, the display control unit 1604 displays on the display 110, the item details of the items C1 to C3 that are represented by the nodes N1 to N3 belonging to tier 1 of the tree-structure 2600.

The detecting unit 1605 detects an input operation selecting an item Ci among the items that are represented by the nodes belonging to tier h, displayed on the display. For example, the detecting unit 1605 detects an input operation selecting an item Ci among the items C1 to C3 that are represented by the nodes N1 to N3 belonging to tier 1, displayed on the display 110.

If an input operation selecting an item Ci has been detected, the display control unit 1604 displays on the display 110, the item details of the items that are represented by the child nodes of the node Ni representing the item Ci. For example, if an input operation selecting the item C1 has been detected, the display control unit 1604 displays on the display 110, the item details of the items C4 to C5 that are represented by the child nodes N4 to N5 of the node N1 that represents the item C1.

The instructing unit 1606 outputs a record instruction to the camera 303, when an input operation selecting an item that is represented by a leaf node of the tree-structure 2600 has been detected. Here, a leaf node is a node that has no child node. For example, assuming the node N7 is a leaf node, if an input operation selecting the item C7, which is represented by the node N7 is detected, the instructing unit 1606 outputs a record instruction to the camera 303.

Thus, by arranging the group of items C1 to Cn in a hierarchal structure, the item details of items to be displayed concurrently on the display 110 can be limited. Further, each time the worker W performs an input operation selecting an item Ci, the item details of the items to be displayed on the display 110 become more detailed, enabling the intended purpose of the worker W to be narrowed down.

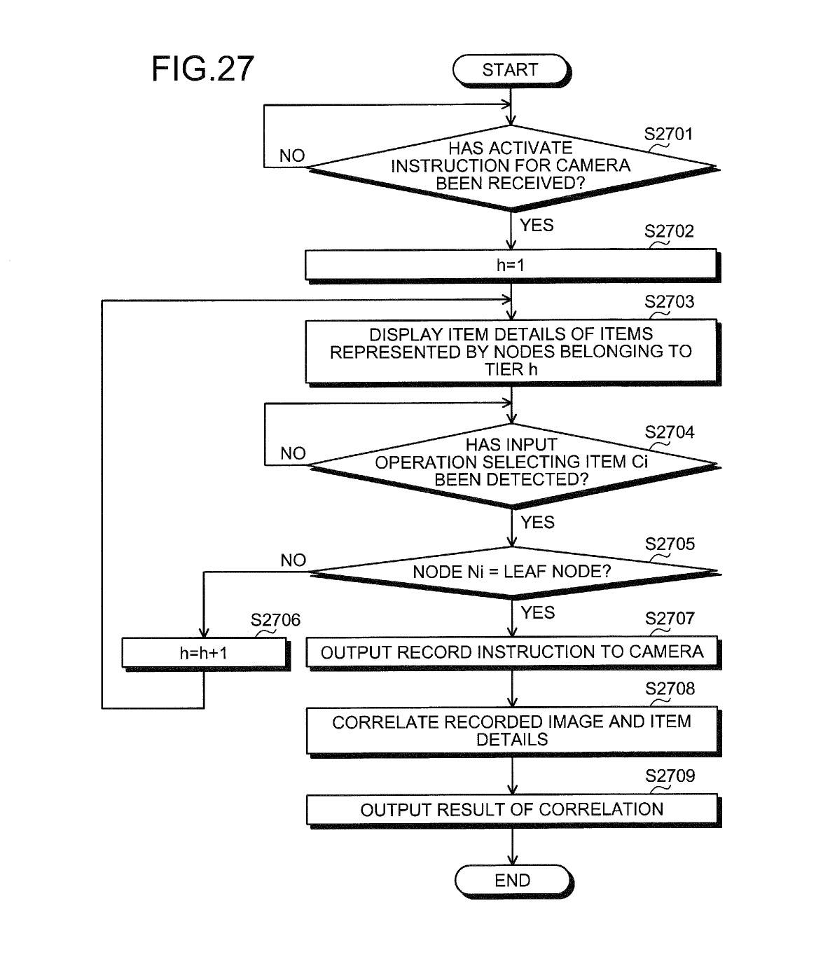

Next, a procedure of the work support process performed by the mobile device 101 according to the third embodiment will be described. FIG. 27 is a flowchart of a procedure of the work support process performed by the mobile device according to the third embodiment.

In the flowchart depicted in FIG. 27, the mobile device 101 determines whether an activate instruction for the camera 303 has been received (step S2701). Here, the mobile device 101 awaits receipt of an activate instruction for the camera 303 (step S2701: NO).

When an activate instruction for the camera 303 has been received (step S2701: YES), the display control unit 1604 sets tier h of the tree-structure 2600 to be “h=1” (step S2702). The display control unit 1604 displays on the display 110, the item details of the items that are represented by the nodes belonging to tier h of the tree-structure 2600 (step S2703).

Thereafter, the mobile device determines whether an input operation selecting an item Ci among the items represented by the nodes belonging to tier h, displayed on the display 110 has been detected by the detecting unit 1605 (step S2704). Here, the mobile device 101 awaits a detection of an input operation by the detecting unit 1605 (step S2704: NO), and when an input operation has been detected (step S2704: YES), determines whether the node Ni representing the items Ci is a leaf node (step S2705).

If the node Ni representing the item Ci is a leaf node (step S2705: NO), the display control unit 1604 increments “h” of tier h in the tree-structure 2600 (step S2706), and returns to step S2703. On the other hand, if the node Ni representing the item Ci is a leaf node (step S2705: YES), the instructing unit 1606 outputs a record instruction to the camera 303 (step S2707).

The correlating unit 1607 correlates the image recorded by the camera 303 and the item details of the selected item Ci (step S2708). The output unit 1608 outputs the result of the correlation (step S2709), ending a series of operations according to the present flowchart.

Thus, for each tier h of the tree-structure 2600, the item details of the items represented by the nodes belonging to the tier h can be displayed on the display 110 and the item details of the times to be displayed concurrently on the display 110 can be limited.

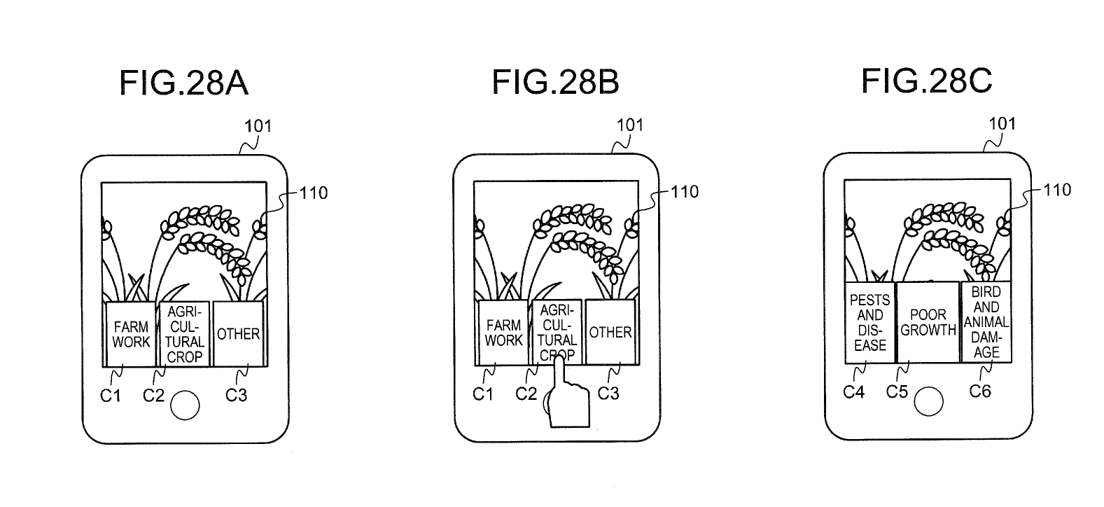

Next, screen examples of the display 110 of the mobile device 101 will be described. FIGS. 28A to 30B are diagrams depicting screen examples of the display of the mobile device according to the third embodiment.

In FIG. 28A, the subject and item details “farm work”, “agricultural crop”, and “other” of the items C1 to C3 are displayed on the display 110 of the mobile device 101.

In FIG. 28B, consequent to a detection of an input operation selecting the item C2, the subject and the item details “pests and disease”, “poor growth”, and “bird and animal damage” of the items C4 to C6 are displayed on the display 110 of the mobile device 101. In other words, the node N2 representing the item C2 is not a leaf node.

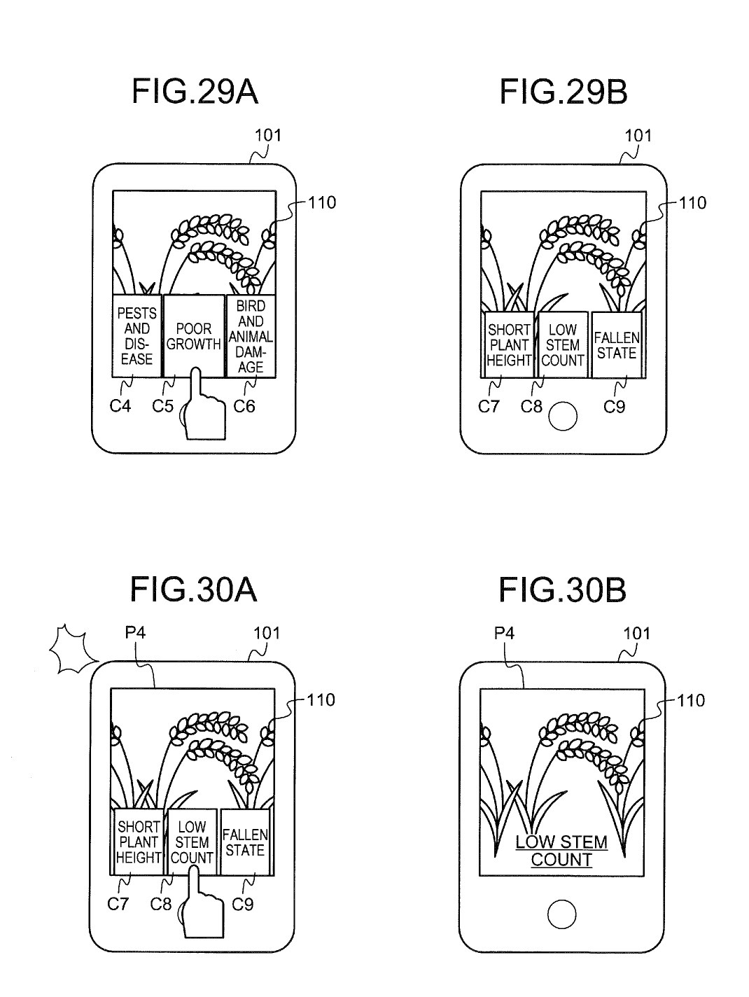

In FIG. 29A, consequent to a detection of an input operation selecting the item C5, the subject and the item details “short plant height”, “low stem count”, and “fallen state” of the items C7 to C9 are displayed on the display 110 of the mobile device 101 in FIG. 29B. In other words, the node N5 representing item C5 is not a leaf node.

In FIG. 30A, consequent to a detection of an input operation selecting the item C8, an image P4 is recorded by the camera 303. In other words, the node N8 representing the item C8 is a leaf node.

In FIG. 30B, the image P4 recorded by the camera 303 and the item details “stem count low” of the item C8 representing the intended purpose of the worker W using the mobile device 101 are correlated and displayed on the display 110.

In FIG. 28A, if an input operation selecting the item C3 is detected, the image P4 is recorded by the camera 303. In other words, the node N3 representing the item C3 is a leaf node.

The mobile device 101 according to the third embodiment enables for each tier h of the tree-structure 2600 arranging the group of items C1 to Cn in a hierarchal structure, the item details of the items represented by the nodes belonging to the tier h to be displayed on the display 110, thereby enabling the item details of the items to be displayed concurrently on the display 110 to be limited.

The mobile device 101 according to the third embodiment enables for each input operation selecting an item Ci performed by the worker W, transition between tiers and the switching of the item details of the items to be displayed on the display 110. Further, the mobile device 101 enables for each input operation selecting an item Ci performed by the worker W, further details of the item details to be displayed on the display 110.

Thus, the mobile device 101 according to the third embodiment enables the item details of the items to be displayed concurrently on the display 110 to be limited and more options that may be the intended purpose to be presented to the worker W.

The work support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to one aspect of the embodiments, an image and an intended purpose can be correlated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A mobile device comprising:
a processor; and
an imaging unit that records subjects as images, wherein
the processor is configured to:
detect an input operation of selecting an item among a group of items representing any among an object and an event possibly motivating a recording of a subject by a person engaged in farm work,
output a record instruction to the imaging unit upon detecting the input operation,
correlate the item for which the input operation is detected and an image that is recorded by the imaging unit consequent to the output record instruction, and
output a result of correlation.

2. The mobile device according to claim 1, further comprising
a display unit that displays item details of each item among the group of items representing any among the object and the event, wherein
the processor is further configured to
acquire position information of the mobile device, and
set, as the item details of the items, information that characterizes a field that is near the mobile device and that is identified from the acquired position information.

3. The mobile device according to claim 2, wherein
the processor sets, as the item details of the items, information that characterizes a crop cultivated in the field that is near the mobile device.

4. The mobile device according to claim 2, wherein
the processor sets, as the item details of the items, information that characterizes work details of the farm work to be performed in the field that is near the mobile device.

5. The mobile device according to claim 2, wherein
the processor is further configured to:
transmit the position information of the mobile device to an information providing apparatus that has position information for each field among a group of fields dispersed over various areas, and
receive from the information providing apparatus consequent to transmitting the position information of the mobile device, information that characterizes the field that is near the mobile device, and
the processor sets the received information as the item details of the items.

6. The mobile device according to claim 5, wherein
the processor receives from the information providing apparatus consequent to transmitting the position information of the mobile device, information that characterizes a crop cultivated in the field that is near the mobile device, and
the processor sets, as the item details of the items, the received information characterizing a crop cultivated in the field that is near the mobile device.

7. The mobile device according to claim 5, wherein
the processor receives from the information providing apparatus consequent to transmitting the position information of the mobile device, information that characterizes work details of the farm work to be performed in the field that is near the mobile device, and
the processor sets, as the item details of the items, the received information characterizing work details of the farm work to be performed in the field that is near the mobile device.

8. The mobile device according to claim 5, wherein
the processor receives from the information providing apparatus consequent to transmitting the position information of the mobile device, information that characterizes a pest specific to a crop cultivated in the field that is near the mobile device, and
the processor sets, as the item details of the items, the received information characterizing a pest specific to a crop cultivated in the field that is near the mobile device.

9. The mobile device according to claim 5, wherein
the processor receives from the information providing apparatus consequent to transmitting the position information of the mobile device, information that characterizes a disease specific to a crop cultivated in the field that is near the mobile device, and
the processor sets, as the item details of the items, the received information characterizing a disease specific to a crop cultivated in the field that is near the mobile device.

10. The mobile device according to claim 5, wherein
the processor transmits to the information providing apparatus, identification information of a worker using the mobile device,
the processor receives from the information providing apparatus consequent to transmitting the identification information of the worker, information that characterizes work details of the farm work to be performed by the worker, and
the processor sets, as the item details of the items, the received information characterizing work details of the farm work to be performed by the worker.

11. The mobile device according to claim 1, wherein
the processor is further configured to
control the display unit to display the item details of the items that are represented by nodes belonging to a tier of a tree-structure that arranges the items representing any among the object and the event, as nodes in a hierarchal structure,
the processor detects an input operation selecting an item among the items represented by the nodes belonging to the tier, displayed on the display unit,
the processor upon detecting the input operation, controls the display unit to display the item details of the items that are represented by child nodes of the node that represents the item for which the input operation is detected, and
the processor upon detecting an input operation selecting an item that is represented by a leaf node of the tree-structure, outputs the record instruction to the imaging unit.

12. A computer-readable recording medium storing a work support program causing a computer to execute a process comprising:
detecting an input operation of selecting an item among a group of items representing any among an object and an event possibly motivating a person engaged in farm work to record a subject as an image;
outputting upon detecting the input operation, a record instruction to an imaging unit that records the subject as an image;
correlating the item for which the input operation is detected and the image recorded by the imaging unit consequent to the output record instruction; and
outputting a result of correlation.

13. An information providing method executed by a computer, the information providing method comprising:
receiving from a mobile device, position information of the mobile device;
retrieving based on the received position information of the mobile device and position information of each field among a group of fields dispersed over various areas, a field among the group of fields; and
transmitting to the mobile device, information that characterizes the retrieved field, as information representing any among an object and an event possibly motivating a person engaged in farm work to record an image of the field.

14. The information providing method according to claim 13, further comprising
extracting from a database storing information that characterizes crops cultivated in the group of fields, information that characterizes a crop cultivated in the retrieved field, wherein
the transmitting includes transmitting to the mobile device as the information representing any among the object and the event, the extracted information characterizing a crop cultivated in the retrieved field.

15. The information providing method according to claim 14, wherein
the database stores information that characterizes work details of farm work to be performed in the group of fields,
the extracting includes extracting from the database, information that characterizes work details of the farm work to be performed in the retrieved field, and
the transmitting includes transmitting to the mobile device as the information representing any among the object and the event, the extracted information characterizing work details of the farm work to be performed in the retrieved field.

16. The information providing method according to claim 14, wherein
the database correlates and stores the crops and information that characterizes harmful pests specific to the crops,
the extracting includes extracting from the database, information that characterizes a harmful pest specific to a crop cultivated in the retrieved field, and
the transmitting includes transmitting to mobile device as the information representing any among the object and the event, the extracted information characterizing a harmful pest specific to a crop cultivated in the retrieved field.

17. The information providing method according to claim 14, wherein
the database correlates and stores the crops and information that characterizes harmful diseases specific the crops,
the extracting includes extracting from the database, information that characterizes a harmful disease specific to a crop cultivated in the retrieved field, and
the transmitting includes transmitting to the mobile device as the information representing any among the object and the event, the extracted information characterizing a harmful disease specific to a crop cultivated in the retrieved field.

18. The information providing method according to claim 14, wherein
the database correlates and stores worker identification information and information characterizing work details of farm work to be performed by workers,
the receiving includes receiving from the mobile device, worker identification information of a worker using the mobile device,
the extracting includes extracting from the database, information that is correlated with the worker identification information received from the mobile device and that characterizes work details of farm work to be performed by the worker using the mobile device, and
the transmitting includes transmitting to the mobile device as the information representing any among the object and the event, the extracted information characterizing work details of farm work to be performed by the worker using the mobile device.

19. A computer-readable recording medium storing an information providing program causing a computer to execute a process comprising:
receiving from a mobile device, position information of the mobile device;
retrieving based on the received position information of the mobile device and position information of each field among a group of fields dispersed over various areas, a field among the group of fields; and
transmitting to the mobile device, information that characterizes the retrieved field, as information representing any among an object and an event possibly motivating a person engaged in farm work to record an image of the field.
